(19) United States
(12) Patent Application Publication
(10) Pub. No.: US 2016/0203319 A1
(43) Pub. Date: Jul. 14, 2016

(54) System and Method For Providing Technology-Driven End-to-End Managed Security Service Products Through a Security Marketplace

(71) Applicant: Leidos, Inc., Reston, VA (US)

(72) Inventors: Michael Coen, Morgantown, WV (US); Andrew Formica, Morgantown, WV (US); Eric Johnson, Arlington, VA (US); John Lawrence, Potomac Falls, VA (US); Joshua Zangari, Morgantown, WV (US); Jeffrey Zemerick, Bruceton Mills, WV (US)

(73) Assignee: Leidos, Inc., Reston, VA (US)

(21) Appl. No.: 14/994,293

(22) Filed: Jan. 13, 2016

Related U.S. Application Data
(60) Provisional application No. 62/103,147, filed on Jan. 14, 2015.

(51) Int. Cl. G06F 21/57; G06Q 30/00; G06Q 30/06; H04L 29/06

(52) U.S. Cl. CPC G06F 21/577; H04L 63/04; H04L 63/0272; G06Q 30/0185; G06Q 30/0631; H04L 63/1433; G06F 2221/034

(57) ABSTRACT

A platform provides customers with complete and compelling consumption-based service while using the information it gathers to improve the customer's experience. This capability includes cloud integration to monitor the customer's cloud workload which is then used to identify risks and make recommendations on how to mitigate those risks through the management of the customer's security infrastructure. The platform relies upon third party security products from independent security vendors to provide the technology that forms the platform's security portfolio. Through the platform's web-based vendor portal, each vendor maintains its own product information including features sets, target customer demographics, applicable software stacks, compliance/regulatory capabilities and pricing. By cross referencing this product information with specific customer information, the platform can intelligently promote the correct products and capability upgrades at the right time to the right customers.

### CROSS-REFERENCE TO RELATED APPLICATIONS

The present application claims the benefit of priority to similarly titled U.S. Provisional Patent Application 62/013,147 filed Jan. 14, 2015, the entirety of which is incorporated herein by reference.

### BACKGROUND

1. Field of the Embodiments

The present embodiments are generally directed to enterprise network and asset security. More particularly, the embodiments describe a cybersecurity marketplace.

2. Description of Related Art

As businesses adopt the ideas behind cloud computing, i.e., virtualization, pay-per-use pricing and rapid provisioning, there is a need for an accompanying platform to handle the marketing, sales, pre-sales requirements gathering, fulfillment, management and operations of the security solutions that accompany those business applications, including monitoring and matching of vendor solutions with customer needs in an efficient, secure manner.

There is a need for a platform that provides a full range of managed security services and simplifies the delivery of evolving security offerings to accelerate customer adoption of hosting strategies for enterprise applications.

This platform should be reactive to perceived changes to the security of a customer's enterprise digital assets to offer and provide updated and new product offerings from partner vendors in an automated fashion and with minimal intervention, so as to thwart enterprise security threats. Such threats arise, for example, from customer employees who sign up for non-standard services and use web tools outside the enterprise information technology structure. Such events often result in the inadvertent disclosure of sensitive business information and intellectual property.

### SUMMARY OF EMBODIMENTS

The platform of the embodiments described herein allows an organization to provide a complete and compelling consumption-based service for its customers while using the information it gathers to improve the customer's experience. This capability includes cloud integration to monitor the customer's cloud workload which is then used to identify risks and make recommendations on how to mitigate those risks through the management of the customer's security infrastructure. These intelligent and constructive recommendations on how to effectively and seamlessly improve the customer's security posture mesh with the cloud philosophies of rapid deployment, virtualization and pay-per-use.

The embodied platform relies upon third party security products from independent security vendors to provide the technology that forms the embodied platform's security portfolio. Through the platform's web-based vendor portal, each vendor maintains its own product information including features sets, target customer demographics, applicable software stacks, compliance/regulatory capabilities and pricing. By cross referencing this product information with specific customer information, the platform can intelligently promote the correct products and capability upgrades at the right time to the right customers.

The embodied platform also provides security product vendors with access to product/capability adoption rates and usage information which they can leverage to drive their internal product development selection process. The product vendors in-turn constantly provide new and innovative incremental product capabilities while the platform continuously learns more about the supported customers, thus enabling a beneficial feedback-type process for all parties to the platform.

In a first embodiment, a system for the automated provisioning and tracking of cloud-implemented security products for protecting an entity's digital assets includes: a first application programming interface for receiving security product data from one or more security product vendors and storing the security product data in a relational database; a second application programming interface for receiving entity data and storing the entity data in the relational database, wherein the entity data is associated with one or more digital assets of the entity and further wherein the digital assets are accessible through the entity's virtual private cloud; a processing engine for comparing the received entity data with the received security product data and providing at least one recommendation to the entity for a security product from the one or more security product vendors to protect one or more digital assets of the entity; a provisioning component for receiving instructions from the second application programing interface to provision the at least one recommended security product in the entity's virtual private cloud; the processing engine further being configured for continually tracking the provisioned instance of the security product, including usage thereof, and comparing provisioned instance tracking data to additional received security product data from the first application programming interface and additional received entity data from the second application programming interface to continually assess a security risk to one or more digital assets of the entity and provide additional security product recommendations.

In a second embodiment, a method for facilitating the automated provisioning and tracking of cloud-implemented security products for protecting an entity's digital assets includes: receiving via a first application programming interface security product data from one or more security product vendors and storing the security product data in a relational database; receiving via a second application programming interface entity data and storing the entity data in the relational database, wherein the entity data is associated with one or more digital assets of the entity and further wherein the digital assets are accessible through the entity's virtual private cloud; comparing by a processing engine the received entity data with the received security product data; providing to the entity via the first application programming interface at least one recommendation for a security product from the one or more security product vendors to protect one or more digital assets of the entity; receiving by a provisioning component instructions to provision the at least one recommended security product in the entity's virtual private cloud; continually tracking by the processing engine the provisioned instance of the security product, including usage thereof, and comparing provisioned instance tracking data to additional received security product data from the first application programming interface and additional received entity data from the second application programming interface to continually assess a security risk to one or more digital assets of the entity and provide additional security product recommendations.

### GLOSSARY OF ACRONYMS

### AWS: Amazon Web Service

Bot ID: web robot identifier

### CSM: CyberSecurity Marketplace

### DDoS: Distributed Denial of Service

### GUI: Graphical User Interface

### IAM: Identity and Access Management

IDP: identity provider

### IDS: Intrusion Detection System

### ISV: Independent Software Vendor

### MSSP: Managed Security Services Platform

### PenTest: Penetration Test

### Proxy: Proxy Server

### REST: Representational State Transfer

### SaaS: Software as a Service

### SAML: Security Assertion Markup Language

### SIEM: Security Information and Event Management

### SKU: Stock Keeping Unit

### SOAP: Simple Object Access Protocol

### SPoG: Single Pane of Glass

### SSO: Single Sign-On

### VM: Virtual Machine

### VPC: Virtual Private Cloud

### VPN: Virtual Private Network

### WAF: Web Application Firewall

### WSDL: Web Services Description Language

### UTM: Unified Threat Management

### BRIEF DESCRIPTION OF FIGURES

The following Figures are to be considered in conjunction with the detailed description below:

FIG. 1 is a high level schematic of a cybersecurity ecosystem, including a CyberSecurity Marketplace (CSM), in accordance with an embodiment described herein;

FIG. 2 is a schematic of a recommendation engine of a CyberSecurity Marketplace (CSM), in accordance with an embodiment described herein;

FIG. 3 is a schematic of a single sign-on (SSO) process of a CyberSecurity Marketplace (CSM), in accordance with an embodiment described herein;

FIG. 4 is a schematic of a new product provisioning process using the CyberSecurity Marketplace (CSM), in accordance with an embodiment described herein;

FIG. 5 is a schematic of a provisioned product heartbeat API process of a CyberSecurity Marketplace (CSM), in accordance with an embodiment described herein; and

FIGS. 6a-6f illustrate an exemplary entity relationship diagram (ERD) for a CyberSecurity Marketplace (CSM) in accordance with an embodiment described herein.

### DETAILED DESCRIPTION

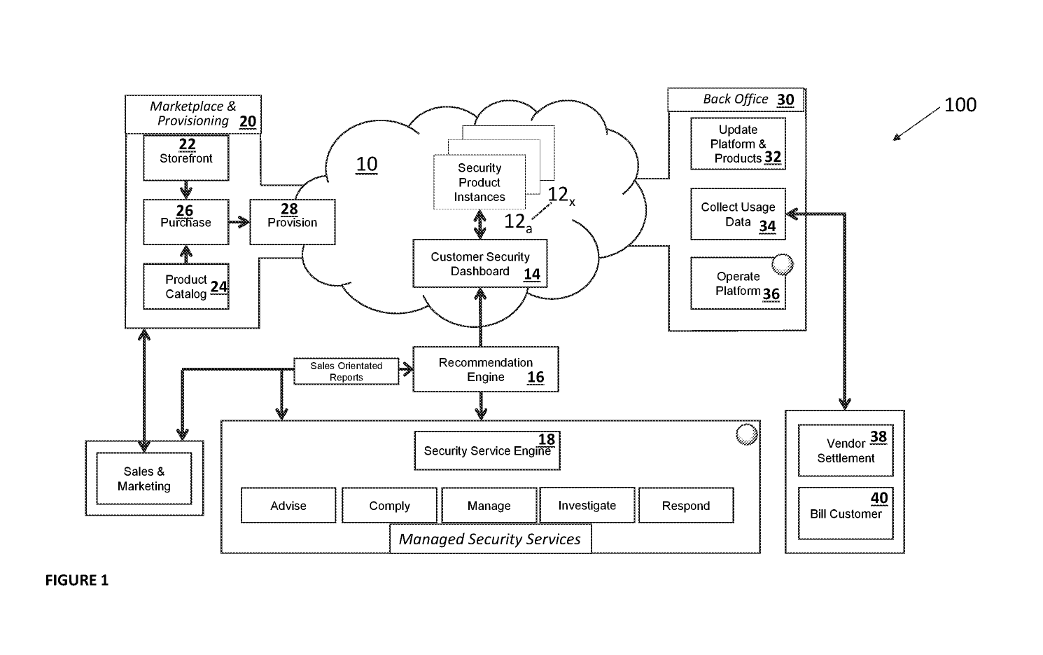

Referring to FIG. 1, a high level schematic of an overall cybersecurity ecosystem 100 includes components and functionality of the embodied CSM. The cloud 10 is representative of the customer's virtual private cloud (VPC) which runs instances of various security products to protect customer's enterprise assets. A customer security dashboard 14, provides an interface to the recommendation engine 16 and the MSS functionality which is informed by the security service engine 18. MSS functionality includes, for example, advise, comply, manage, investigate and respond functions. It will be appreciated that while engines 16 and 18 are shown and described as separate components, one skilled in the art understands that the functionality of each engine would be implemented on a single processing or server component with separate functionality modules. Though not discussed in detail in this application, the security services engine 18 functionality, i.e., advise, comply, manage, investigate and respond functions, includes implementation of cybersecurity consulting services which may involve development of a security infrastructure for an enterprise (customer), management of the security infrastructure or parts of the security infrastructure, assessment and monitoring of the security of enterprise information technology (IT) assets, responding to security threats and training enterprise personnel to perform cybersecurity related tasks to protect the enterprise's IT assets. Accordingly, the enterprise information used by the recommendation engine 18 to perform MSS functionality is directly applicable to the process employed by the recommendation engine 16 which is discussed in detail herein.

The marketplace and provisioning functionality 20 may include a virtual store front (web-based) 22, product catalog 24, purchasing functionality 26 and provisioning functionality 28. The back office functionality 30 may include functions and components to update platform and product 32, collect usage data 34 and operate the platform 36, as well as facilitate vendor settlement 38 and customer invoicing 40.

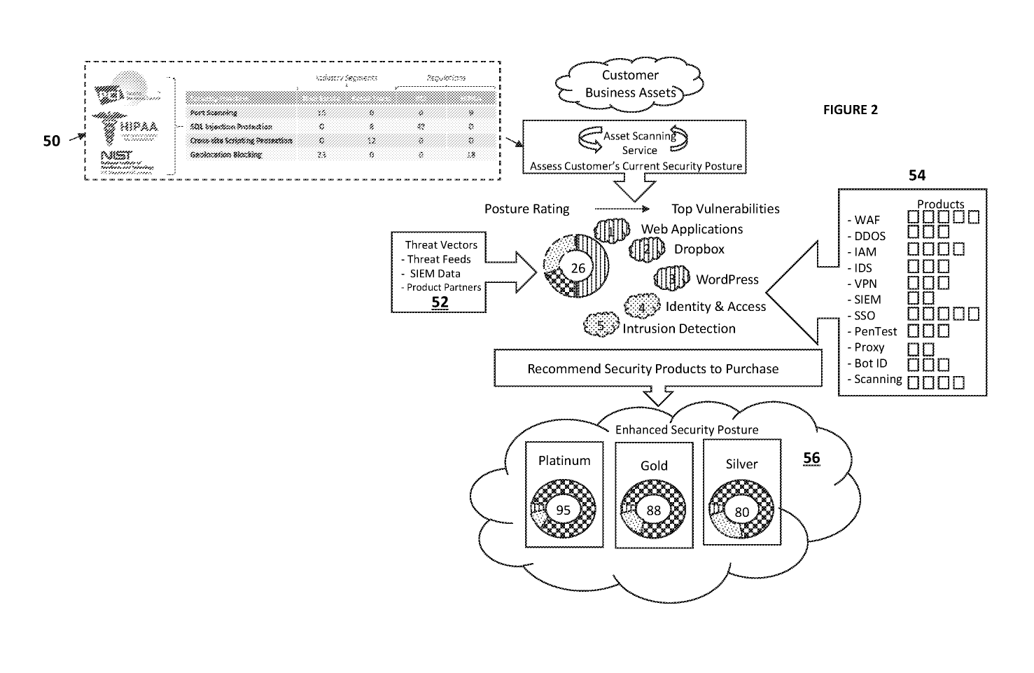

A key component of the CSM of the cybersecurity ecosystem 100 is the recommendation engine 16. Referring to FIG. 2, the recommendation engine 16 architecture is constantly monitoring the customer's security posture/exposure and matching it with the security portfolio of available vendor security products and product capabilities. The matching information is then used to intelligently promote and market one or more vendor solutions through a number of online interfaces and/or offline reports provided directly to the customer, to the customer's advocate (a customer experience or security operations manager) and to the sales team for direct sales. In a particular exemplary embodiment, the recommendation engine includes Apache Hadoop, Apache Spark infrastructure with an Apache Mahout-driven machine learning engine.

Customer security information is gathered manually through the web portal as well as through automated systems such as assessments, cloud monitoring, vendor-provided threat information, and vulnerability feeds and is provided to the recommendation engine 16 in the form of, e.g., compliance requirements data 50 and threat vectors 52. For example, the process for initial customer provisioning of a security product solution by the CSM includes an onboarding questionnaire (or survey) to gather customer demographics (e.g., industry, compliance requirements) and digital (IT) assets (applications, datastores). Such information is used to determine what, if any, particular industry security standards are applicable to the customer's enterprise. The applicable compliance data 50, e.g., PCI, HIPAA and NIST regulations or standards, is accessed and/or provide to the CSM and applied by the recommendation engine during assessment. Automated systems conduct both active and passive network data gathering, assessments and audits to build and continually update a more detailed customer cybersecurity dossier.

Security product vendors, including third-party vendors, populate a product database of the recommendation engine 16 via a vendor web portal (not shown). Through this vendor web portal, the attributes of each base vendor product and product capability is entered into the product database 54. Each product and product capability includes attributes around the demographics and digital assets to which it is applicable. This product information is then cross-referenced with the customer security information by the recommendation engine to build and constantly update customer specific security product recommendations. Examples of categories of digital asset security products include, but are not limited to: Firewall, UTM & Network Security (WAF, DDoS); Identity Management (IAM); Intrusion and Threat Detection (IDS); virtual private network (VPN) security products; vulnerability scanner & penetration testing (PenTes)t; Proxy Server; Bot ID; data encryption, log storage & management and vulnerability scanning tools. The product recommendations generated by the recommendation engine are presented across a number of different reports and portals tailored for the specific user (customer) populations. Products are marketed directly to the end customer through the customer's security portal where recommendations are mixed in with the customer's security portal or dashboard.

The recommendation engine 16 utilizes the customer digital asset and security information 50, 52 and the vendor product information 54 to perform on-going assessments. By way of example only, a recommendation engine identifies vulnerable software utilized by a customer, e.g., Apache Tomcat (various versions). The recommendation engine maps this software to vulnerabilities identified and supported by the National Institute of Standards and Technology's (NIST's) National Vulnerabilities Database (NVD) and maintained by US-CERT, which provides a list of Common Vulnerabilities and Exposures (CVE). In this particular example, the vulnerability identified for this software during the assessment is “CVE-2013-4444 Unrestricted file upload.” Next, assuming that a vendor (e.g., ISV) has provided and maintained a product SKU with the CME that is associated with protecting against this particular CVE, the recommendation engine 16 further maps the vulnerability to one or more product SKUs, e.g., in this particular case, Radware AppWall code injection SKU is identified and mapped. Accordingly, the present embodiments would provide a report to the customer which includes information about the identified software vulnerability and the proposed vendor product which may be purchased to protect against the identified vulnerability.

Next FIG. 2 provides an exemplary posture report 56 to the customer that indicates varying levels of enhanced security posture for the identified top customer vulnerabilities that may be achieved through provisioning of new or updated products from vendors, including from most (e.g., platinum at 95% in this example) to least (silver at 80% in this example). This allows the customer to select (or not select) the level of enhancement, including vendor product or combination or products, to be provisioned in their cloud based on a variety of factors such as product cost and digital asset risk. In addition, various entities within the CSM, e.g., the customer experience, security operations center and sales teams may also be provided with reports through their respective dashboards which convey the posture information. The resulting recommendation reports accessible through the customer security portal may include specific details related to the digital asset vulnerability that has been identified, indicating the proposed product and inquiring about customer's next step. Referring to the particular example above, the recommendation report would identify the Radware AppWall code injection SKU as a product for addressing the customer's identified Apache Tomcat vulnerability. Additional recommendation examples are listed below and categorized in accordance with growth consumption in order to provide specific, non-limiting examples of the numerous and varied mappings and assessments which are contemplated by the present embodiments. One skilled in the art appreciates that there are numerous possible recommendation outcomes which may be generated by the recommendation engine and that these examples are in no way intended to be limiting.

| Consumption Growth | Recommendation Example |
|---|---|
| Growth of an existing | “The firewall at 27.182.81.28 is not being scanned per PCI |
| product to protect | requirements. Would you like to increase your Acme Scanner |
| more assets. | license to include this device?” |
| Growth of completely | “The PCI-DSS requires an application firewall. Have you |
| new products. | considered installing Acme Networks Intelli-WAF?” |
| Growth through new | “We detected that mobile devices are accessing your Sharepoint |
| product feature. | server. Your installed AcmeNet Firewall has a new feature that can |
| | be used to protect those devices. Would you like more information |
| | about that new capability?” |
| Growth through | “Your AcmeNet Email Spam Filter is running at 500 |
| increase usage. | emails/second and rated for 600 emails/second. Would you like |
| | information about upgrading your usage bundle? |
| Growth through new | “The host at 31.41.5.9 is running an SSH implementation that is |
| vulnerability | vulnerable to the Heartbleed exploit. You can protect this device |
| identification. | by using Acme's SSH Proxy to protect this device. Learn more?” |

As referenced above, the cybersecurity ecosystem 100 of the present embodiments provides facilitated onboarding of customers and security products via intuitive web forms that collect all information required to automatically provision available security products into a customer's dedicated virtual private cloud (VPC). The marketplace and provisioning functionality 20 supports automated provisioning into a host of cloud platforms, including AWS and Openstack, and can be updated to support additional cloud platforms as they are developed. Once customers and products are added into the platform, provisioning into supported customer cloud platforms can be achieved through just a few simple selections via the customer and vendor facing web portals.

The following paragraphs provide a detailed description of an exemplary method for facilitating the addition of vendor products (FIG. 1, 24; FIG. 2, 54) to the cybersecurity ecosystem 100 and participation in the CSM functionality. While the following process as described is detailed in nature and includes pointers to particular locations and types of cloud platforms, e.g., AWS and Openstack, one skilled in the art recognizes the variations from the detailed process that fall squarely within the scope of the embodiments.

CSM automatically populates the virtual machine (VM) instance provisioned when a customer orders a product via the CSM product catalog with four key configuration items (variables). The four configuration items are as follows:
1. A Product Instance calling the Partner Metrics Service identifies itself by its Instance ID—a unique identifier given to the VM instance by the cloud provider.
   a. CSM_INSTANCE_ID (External ID)
   b. This is also available by making a ‘get’ request to localhost at the appropriate locations for the cloud provider:
2. The base Partner Metrics Service URL that can be used to instantiate a REST implementation of the Java client interface.
   a. CSM_REST_ENDPOINT
3. The Partner Metrics Service URL of the WSDL for the SOAP implementation, which can be used to instantiate a SOAP implementation of the Java client interface.
   a. CSM_SOAP_ENDPOINT
4. The random instance security token required for authenticated use of the Partner Metrics Service.
   a. CSM_SECURITY_TOKEN

After ordering a SaaS product via the CSM product catalog, CSM automatically sends an email to the SaaS partner (product vendor or ISV) that contains the following:
1. Request Type: An enumeration representing the type of request being made for SaaS provisioning purposes. The possible values are: Subscribe, Unsubscribe, or Update (In the context of these configuration items it should always be of the value “Subscribe”).
2. Platform Operator: The name of the CSM platform operator is included for documentation purposes.
3. Platform Operator Endpoint: The endpoint URL of the CSM platform operator is included for documentation purposes.
4. Customer Name: The name of the end customer responsible for the request is included for documentation purposes.
5. Customer Domain: The domain of the customer responsible for the request is included for documentation purposes.
6. Customer Instance ID (External ID): Unique subscription identifier established by CSM. SaaS products calling the Partner Metrics Service must reference the External ID when providing information about a specific customer subscription.
7. Admin First Name: First name of the user designated as the customer's point of contact.
8. Admin Last Name: Last name of the user designated as the customer's point of contact.
9. Admin Email: Email address of the user designated as the customer point of contact.
10. Name: The name of the SaaS product, along with the associated SKUs that have been activated, will be provided for documentation purposes.
   a. SKU Name
   b. SKU ID (The ID of the SKU as defined by the product partner)
      The following is a sample provisioning message sent to SaaS product partners (vendors) for subscribing new customers of the CSM:

### Request Type: Subscribe

### Platform Operator: Platform Operator

Platform Operator Endpoint: https://csm.sampleplatformoperator.com/Customer

### Name: Sample Customer

Customer Domain: http://samplecustomer.com/services
Customer Instance ID: 5f2d4eaa-0d91-4620-9fb7-6731e8bd491a

### Admin First Name: Sample

### Admin Last Name: Admin

Admin Email: admin@samplecustomer.com

### Name: SaassyProduct

SKU Name: Application Manager

SKU ID: Partner Sku 1

SKU Name: Another SKU

SKU ID: Partner Sku 2

SKU Name: The Best Feature

SKU ID: Partner Sku 3

Requests to the Partner Metrics Service, for provisioned VM products, are authorized using the environment configuration variables mentioned above. Requests are expected to have an HTTP header of the form:

CSM-Authorization: <CSM_INSTANCE_ID>:<CSM_SECURITY_TOKEN>
Failure to add this header will result in a 400 Bad Request HTTP Response.
Failure to authorize provided credentials will result in a 401 Unauthorized HTTP Response.

Requests to the Partner Metrics Service that do not fall under the domain above for provisioned VM products, are alternatively authorized using signature validation. This requires partners to generate a public/private RSA key pair, where the public key is provided to the back office for later signature validation. The public key should be formatted as a valid X.509 certificate. An example walkthrough for creation of a valid certificate for testing purposes is provided below (using a bash environment):
a. Generate the private key with the command:
   ‘openssl genrsa -out <testprivkeyname>.pem 4096’
b. Generate the corresponding public key certificate with the command:
   ‘openssl req -new -x509 -key <testprivkeyname>.pem -out <testpubkeyname>.pem -days 1095’
c. Submit the entire public key to CSM POC
   By doing this, partners (vendors) will have enabled their use of the Partner Metrics Service. They may proceed with submission of their requests to the endpoints specified for their usage and health, described further herein. These requests are expected to have an HTTP header of the form:
   CSM-Message-Signature: <partnerAccountNumber>:<messageSignature>
   Any and all signatures should be generated using the request's message body as the content on which to sign using the partner's private key. Failure to add this header will result in a 400 Bad Request HTTP Response. Failure to authorize provided credentials will result in a 401 Unauthorized HTTP Response.

The WSDL for the Product Partner Service SOAP endpoint is generated at runtime based on implementation and is available at the URL:

<protocol><host>(:<port>)/<context>*/soap/partnerMetricsService?wsdl
*<context> is optional depending on the deployment environment.
Below are examples both with and without the context.
http://<host>:8080/server/soap/partnerMetricsService?wsdl
http://<host>:8080/soap/partnerMetricsService?wsdl
   The WSDL found at the specified location primarily defines the different operations and document binding to use for the SOAP service. It imports another WSDL, which defines the messages themselves.

There are a number of different REST resources exposed for VM product partners, each of which consume the media type “application/json”:
1. rest/partnerMetricsService/cloudSubscriptions/{externalId}/status
   Accepts HTTP PUT requests for the purpose of updating the status of an active product instance.
2. rest/partnerMetricsService/cloudSubscriptions/{externalId}/activeSkus
   Accepts HTTP PUT requests for the purpose of activating/deactivating SKUs on a product instance.
3. rest/partnerMetricsService/cloudSubscriptions/{externalId}/usageDetails
   Accepts HTTP POST requests for the purpose of submitting a new usage detail about an active product instance.
      All JSON Dates are expected to be in a valid ISO 8061 formatted String.

There are a number of REST resources exposed for all partners, which consumes the media type “application/json”
1. rest/partnerMetricsService/productSubscriptions/activeSkus
   Accepts HTTP PUT requests for the purpose of submitting a list of active SKUs for designated active product instances.
2. rest/partnerMetricsService/productSubscriptions/usageDetails
   Accepts HTTP POST requests for the purpose of submitting a list of usage details about active product instances.
3. rest/partnerMetricsService/assessments
   Accepts HTTP POST requests for the purpose of submitting security assessments for a given customer's product instance that can be used to make further product/SKU recommendations to the target customer.
4. rest/partnerMetricsService/alerts
   Accepts HTTP POST requests for the purpose of submitting instance action alerts for a given customer's product instance that can be used to notify the customer of any findings of the partner's product(s).
      All JSON Dates are expected to be in a valid ISO 8061 formatted String.
      Each operation has a unique request type, which is validated for both structure and content when they are submitted to the various interfaces.

The operations will return a response with a status and a message. The status values will correspond to one of the following:
STALE_DATA
NOT_FOUND
SUCCESSFUL
ERROR
BAD_REQUEST
UPGRADE_AVAILABLE
   The response message either describes the success of the desired operation, or it will attempt to point you in the direction of the issue blocking its successful submission.

All of the methods in the Java Client Library return an instance of the PartnerMetricsServiceResponse class, which represents the details about responses listed above as two guaranteed fields and five optional fields:

### Guaranteed Fields

1. A String representing a response message is returned.
2. A simple enumerated type representing the status values mentioned previously.

### Optional Fields

1. An array of Strings, which contains the partner IDs of all active SKUs on a given instance. (VM Product Partners Only)
2. An array of Strings, which contains the IDs of all SKUs that are pending deactivation on a given instance. (VM Products Only)
3. An array of custom objects, which have three fields:
   a. A string representing the Instance ID to which the response applies.
   b. An array of Strings, which contains the partner IDs of all active SKUs on a given instance.
   c. An array of Strings, which contains the partner IDs of all SKUs that are pending deactivation on a given instance.
4. An array of UsageDetail objects that failed to be persisted during a bulk submission of usage details.
5. A custom object representing the upgrade information for a given instance following an update to a given product's status.
   This response system is limited by the conventions of the libraries used to expose the Service in SOAP and REST. For example: Invalid requests that will not bind to our model using Jackson for JSON and JAXB for SOAP will return messages from those utilities describing the problem with the requests.

The VM Instance Toggle SKUs service operation allows VM product partners to activate or deactivate SKUs on a target product instance as necessary. As customers' needs change they may seek to enable or disable certain features/SKUs on their instance. In the event the VM product partner allows customers to manage SKUs directly within the VM instance itself, the instance must notify CSM of the active SKUs. The changes must come in the form of a list of SKUs that are activated on the target instance. All of the SKUs in the list will be marked as active.

CSM also lets customers manage their VM product subscriptions from within the CSM graphical user interface, allowing users to turn features/SKUs on or off from within the GUI. All changes to the state of a SKU reported to CSM via either this particular service operation or the GUI will be recorded and made accessible at any time as part of the Status Service Operation documented below. The VM product should treat the active SKUs listed in the response as the authoritative set of active SKUs and turn the SKUs on/off accordingly within the VM. CSM will not accept usage for any SKUs that it perceives as off. Therefore, if the product allows users to turn SKUs on or off directly within the product instance itself, it is incumbent on the product to communicate all active SKUs via the Toggle SKUs service prior to submitting SKU usage via the Instance Usage service.

Any SKUs that were previously active within CSM and then disabled through either the CSM GUI or via the Toggle SKUs service operation will have a pending deactivation state in the response. The SKU will remain in the pending deactivation state until CSM receives usage details for the SKU, at which point the SKU will become inactive. Whenever a SKU enters the pending deactivation state, the product instance should prevent users from accessing the associated feature and incurring additional, unwanted usage charges.

The VM Instance Toggle SKUs Service Operation requires a list of SKU IDs represented as Strings to reference the desired SKUs, which should be active on the target instance. The following provide exemplary XML requests and responses using the SOAP web service protocol.

### XML Request Datatype:

<xs:complexType name=“partnerMetricsServiceRequest”>

<xs:sequence>

<xs:element name=“externalId” type=“xs:string”/>

</xs:sequence>

</xs:complexType>
<xs:complexType name=“toggleSkuActivationRequest”>

<xs:complexContent>

<xs:extension base=“tns:partnerMetricsServiceRequest”>

<xs:sequence>

<xs:element name=“activeSkuIds” type=“xs:string”

nillable=“true” minOccurs=“0” maxOccurs=“unbounded”/>

</xs:sequence>

</xs:extension>

</xs:complexContent>

</xs:complexType>

### XML Request Example:

<soapenv:Envelope xmlns:soapenv=“http://schemas.xmlsoap.org/soap/envelope/”
xmlns:soap=“http://soap.svc.metrics.partner.csm.leidos.com/”>

<soapenv:Header/>
<soapenv:Body>

<soap:toggleSkuActivationRequest>

<externalId>TestExternalId</externalId>
<activeSkuIds>TestPartnerSkuId</activeSkuIds>
<activeSkuIds>TestPartnerSkuId2</activeSkuIds>

</soap:toggleSkuActivationRequest>

</soapenv:Body>

</soapenv:Envelope>

### XML Response Type:

<xs:complexType name=“partnerMetricsServiceResponse”>

<xs:sequence>

<xs:element name=“ActiveSkuPartnerIds” type=“xs:string”

maxOccurs=“unbounded”/>

<xs:element name=“PendingDeactivationSkuPartnerIds”

type=“xs:string” maxOccurs=“unbounded”/>

<xs:element name=“responseMessage” type=“xs:string”/>
<xs:element name=“responseStatus”

type=“tns:partnerMetricsServiceErrorType”/>

</xs:sequence>

</xs:complexType>

### XML Response Status Types:

<xs:simpleType name=“partnerMetricsServiceErrorType”>

<xs:restriction base=“xs:string”>

<xs:enumeration value=“STALE_DATA”/>
<xs:enumeration value=“NOT_FOUND”/>
<xs:enumeration value=“SUCCESSFUL”/>
<xs:enumeration value=“ERROR”/>
<xs:enumeration value=“BAD_REQUEST”/>
<xs:enumeration value=“UPGRADE_AVAILABLE”/>

</xs:restriction>

</xs:simpleType>

### XML Response Example:

<S:Envelope xmlns:S=“http://schemas.xmlsoap.org/soap/envelope/”>

<S:Body>

<ns2:saveUsageDetailsResponse

xmlns:ns2=“http://soap.svc.metrics.partner.csm.leidos.com”>

<ActiveSkuPartnerIds>TestPartnerSkuId</ActiveSkuPartnerIds>
<ActiveSkuPartnerIds>TestPartnerSkuId2</ActiveSkuPartnerIds>
<ActiveSkuPartnerIds>TestPartnerSkuId3</ActiveSkuPartnerIds>
<PendingDeactivationSkuPartnerIds>TestPartnerSkuId3</

PendingDeactivationSkuPartnerIds >

<responseMessage>Update to desired SKUs activation status successful

for Cloud Instance having External ID: TestExternalId</responseMessage>

<responseStatus>SUCCESSFUL</responseStatus>

</ns2:saveUsageDetailsResponse>

</S:Body>

</S:Envelope>

The following provide exemplary JSON requests and responses using the REST web service architecture.

### JSON Request Type:

{

“type”: “object”,
“id”:

“urn:jsonschema:com:leidos:csm:partner:metrics:svc:model:ToggleSkusRequest”,

“properties”: {

“activeSkuIds”: {

“type”: “array”,
“items”: {

“type”: “string”

}

}

}

}

### JSON Request Example:

{

“activeSkuIds”: [

“TestPartnerSkuId”,
“TestPartnerSkuId2”

]

}

### JSON Response Example:

{

“responseStatus”: “SUCCESSFUL”,
“responseMessage”: “Update to desired SKUs activation status

successful for Cloud Instance having External ID:TestExternalId”,

“activeSkuPartnerIds”: [

“TestPartnerSkuId”,
“TestPartnerSkuId2”,
“TestPartnerSkuId3”

],
“pendingDeactivationSkuPartnerIds”: [“TestPartnerSkuId3”]

}

The VM Instance Usage service operation allows product partners to provide details about how much a specific product instance is being used. As companies select a vendor's product to be a part of their security architecture within their respective cloud environments, each product instance must provide the CSM with the usage details for each specific instance of your product. The usage details are a list of all the billable Stock Keeping Units (SKUs) within the given product that have been enabled and are being used. See above on Toggling SKUs for details on the message response provided by CSM.

The VM Instance Service Operation requires a SKU ID represented as a String to reference a single SKU for the submitted Usage Detail. This operation requires a float value indicating the usage of the SKU and two dates—a “from date” and a “to date”—which indicate the time period for the usage of the SKU (“fromDate”→“toDate”). The following provide exemplary XML requests and responses using the SOAP web service protocol.

### XML Request Datatype:

<xs:complexType name=“partnerMetricsServiceRequest”>

<xs:sequence>

<xs:element name=“externalId” type=“xs:string”/>

</xs:sequence>

</xs:complexType>
<xs:complexType name=“saveUsageDetailRequest”>

<xs:complexContent>

<xs:extension base=“tns:partnerMetricsServiceRequest”>

<xs:sequence>

<xs:element name=“fromDate” type=“xs:dateTime”/>
<xs:element name=“skuId” type=“xs:string”/>
<xs:element name=“toDate” type=“xs:dateTime” />
<xs:element name=“usage” type=“xs:float”/>

</xs:sequence>

</xs:extension>

</xs:complexContent>

</xs:complexType>

### XML Request Example:

<soapenv:Envelope xmlns:soapenv=“http://schemas.xmlsoap.org/soap/envelope/”
xmlns:soap=“http://soap.svc.metrics.partner.csm.leidos.com/”>

<soapenv:Header/>
<soapenv:Body>

<soap:saveUsageDetailRequest>

<externalId>TestExternalId</externalId>
<fromDate>2013-10-26T21:32:52.000+0000</fromDate>
<partnerSkuId>TestPartnerSkuId</partnerSkuId>
<toDate>2014-10-26T21:32:52.000+0000</toDate>
<usage>100</usage>

</soap:saveUsageDetailRequest>

</soapenv:Body>

</soapenv:Envelope>

### XML Response Status Types:

<xs:simpleType name=“partnerMetricsServiceErrorType”>

<xs:restriction base=“xs:string”>

<xs:enumeration value=“STALE_DATA”/>
<xs:enumeration value=“NOT_FOUND”/>
<xs:enumeration value=“SUCCESSFUL”/>
<xs:enumeration value=“ERROR”/>
<xs:enumeration value=“BAD_REQUEST”/>
<xs:enumeration value=“UPGRADE_AVAILABLE”/>

</xs:restriction>

</xs:simpleType>

### XML Response Example:

<S:Envelope xmlns:S=“http://schemas.xmlsoap.org/soap/envelope/”>

<S:Body>

<ns2:saveUsageDetailsResponse

xmlns:ns2=“http://soap.svc.metrics.partner.csm.leidos.com”>

<ActiveSkuPartnerIds>TestPartnerSkuId</ActiveSkuPartnerIds>
<ActiveSkuPartnerIds>TestPartnerSkuId2</ActiveSkuPartnerIds>
<ActiveSkuPartnerIds>TestPartnerSkuId3</ActiveSkuPartnerIds>
<PendingDeactivationSkuPartnerIds>TestPartnerSkuId3</

PendingDeactivationSkuPartnerIds>

<responseMessage>Usage Details submission successful for

Cloud Instance having External ID:TestExternalId</responseMessage>

<responseStatus>SUCCESSFUL</responseStatus>

</ns2:saveUsageDetailsResponse>

</S:Body>

</S:Envelope>

The following provide exemplary JSON requests and responses using the REST web service protocol.

### JSON Request Type:

{

“type”: “object”,
“id”:

“urn:jsonschema:com:leidos:csm:partner:metrics:svc:model:SaveUsageDetailRequest”,

“properties”: {
“fromDate”: {

“type”: “string”,
“format”: “date-time”,
“required”: true

},
“skuId”: {

“type”: “string”,
“required”: true

},
“usage”: {

“type”: “number”,
“minimum”: 0,
“required”: true

},
“toDate”: {

“type”: “string”,
“format”: “date-time”,
“required”: true

}

}

}

### JSON Request Example:

```
{
    “partnerSkuId”: “TestPartnerSkuId”,
    “fromDate”: “2014-08-20T16:47:35.494+0000”,
    “toDate”: “2014-08-25T16:47:35.494+0000”,
    “usage”: 27
}
```

### JSON Response Example:

```
{
    “responseStatus”: “SUCCESSFUL”,
    “responseMessage”: “Usage Details submission successful for
Product Instance having External ID:TestExternalId”,
    “activeSkuPartnerIds”: [
        “TestPartnerSkuId”,
        “TestPartnerSkuId2”,
        “TestPartnerSkuId3”
    ],
    “pendingDeactivationSkuPartnerIds”: [“TestPartnerSkuId3”]
}
```

A key feature of the CSM platform is that it can provide the status of each provisioned VM instance at the application level. If the CSM platform does not receive an update for a given time period, then a message is sent to the customer and the CSM Security Operations Center for a deeper investigation.

Product partners are responsible for providing customers with a means to upgrade their products. Product upgrades are dependent on a pre-defined maintenance window and user authorization of the upgrade for their product instance(s). When a status update is sent to the server, the product instance status's version is compared with the current product version. If the two versions are different the server will send a response back containing upgrade information. See above regarding Toggling SKUs for details on the active SKUs list provided in the CSM response.

The request accepts three potential product instance statuses in the form of an enumerated type called CloudSubscriptionStatusType, which allows for values of “OFFLINE”, “ONLINE”, or “LEARNING”. In addition, the request has a string field that will typically be set to the currently running product instance's version, but can be set to a new value after a product instance is upgraded to a new version.

The request also requires a float value be given, indicating the average utilization of a given product instance's resources. The following provide exemplary XML requests and responses using the SOAP web service protocol.

### XML Request Datatype:

```
<xs:complexType name=“partnerMetricsServiceRequest”>
    <xs:sequence>
        <xs:element name=“externalId” type=“xs:string”/>
    </xs:sequence>
</xs:complexType>
<xs:complexType name=“updateStatusRequest”>
    <xs:complexContent>
        <xs:extension base=“tns:partnerMetricsServiceRequest”>
            <xs:sequence>
                <xs:element name=“status”
                type=“tns:cloudSubscriptionStatusType”/>
                <xs:element name=“utilization” type=“xs:float”/>
                <xs:element name=“currentVersion”
                type=“xs:string”/>
            </xs:sequence>
        </xs:extension>
    </xs:complexContent>
</xs:complexType>
```

### XML Request Example:

```
<soapenv:Envelope xmlns:soapenv=“http://schemas.xmlsoap.org/soap/
envelope/” xmlns:soap=“http://soap.svc.metrics.partner.csm.leidos.com/”>
    <soapenv:Header/>
    <soapenv:Body>
        <soap:updateStatusRequest>
            <externalId>TestExternalId</externalId>
            <status>ONLINE</status>
            <utilization>93</utilization>
            <currentVersion>1.0</currentVersion>
        </soap:updateStatusRequest>
    </soapenv:Body>
</soapenv:Envelope>
```

### XML Response Example (No Upgrade):

```
<S:Envelope xmlns:S=“http://schemas.xmlsoap.org/soap/envelope/”>
    <S:Body>
        <ns2:updateStatusResponse
xmlns:ns2=“http://soap.svc.metrics.partner.csm.leidos.com”>
            <ActiveSkuPartnerIds>TestPartnerSkuId
            </ActiveSkuPartnerIds>
            <ActiveSkuPartnerIds>TestPartnerSkuId2
            </ActiveSkuPartnerIds>
            <ActiveSkuPartnerIds>TestPartnerSkuId3
            </ActiveSkuPartnerIds>
            <PendingDeactivationSkuPartnerIds>
TestPartnerSkuId3</PendingDeactivationSkuPartnerIds>
            <responseMessage>Status updated successfully for Cloud
Instance having External ID:TestExternalId</responseMessage>
            <responseStatus>SUCCESSFUL</responseStatus>
        </ns2:updateStatusResponse>
    </S:Body>
</S:Envelope>
```

### XML Response Example (Upgrade Available):

```
<S:Envelope xmlns:S=“http://schemas.xmlsoap.org/soap/envelope/”>
      <S:Body>
            <ns2:updateStatusResponse
xmlns:ns2=“http://soap.svc.metrics.partner.csm.leidos.com”>
                  <ActiveSkuPartnerIds>TestPartnerSkuId</ActiveSkuPartnerIds>
                  <ActiveSkuPartnerIds>TestPartnerSkuId2</ActiveSkuPartnerIds>
                  <ActiveSkuPartnerIds>TestPartnerSkuId3</ActiveSkuPartnerIds>
                  <PendingDeactivationSkuPartnerIds>TestPartnerSkuId3</
PendingDeactivationSkuPartnerIds>
                  <responseMessage>Status updated successfully for Cloud Instance having
External ID:TestExternalId and an upgrade is available.</responseMessage>
                  <responseStatus>UPGRADE_AVAILABLE</responseStatus>
                  <upgradeInformation>
                        <maintenceEnd>2014-07-30T15:31:16.228-04:00</maintenceEnd>
                        <maintenceStart>2014-07-30T18:31:16.228-04:00</maintenceStart>
                        <newVersion>2.0</newVersion>
                        <url>http://productUpgradeUrl</url>
                  </upgradeInformation>
            </ns2:updateStatusResponse>
      </S:Body>
</S:Envelope>
```

The following provide exemplary JSON requests and responses using the REST web service protocol.

### JSON Request Type:

```
{
      “type”: “object”,
      “id”:
“urn:jsonschema:com:leidos:csm:partner:metrics:svc:model:
UpdateStatusRequest”,
      “properties”: {
            “utilization”: {
                  “type”: “number”,
                  “minimum”: 0,
                  “maximum”: 100,
                  “required”: true
            },
            “status”: {
                  “type”: “string”,
                  “enum”: [
                        “OFFLINE”,
                        “ONLINE”,
                        “LEARNING”
                  ],
                  “required”: true
            },
            “currentVersion”: {
                  “type”:“string”,
                  “required”:true
            }
      }
}
```

### JSON Request Example:

```
{
      “status”: “ONLINE”,
      “utilization”: 33,
      “currentVersion”: “1.0”
}
```

### JSON Response Example (No Upgrade):

```
{
      “responseStatus”: “SUCCESSFUL”,
      “responseMessage”: “Status updated successfully for Cloud
Instance having External ID:TestExternalId”,
      “activeSkuPartnerIds”: [
            “TestPartnerSkuId”,
            “TestPartnerSkuId2”,
            “TestPartnerSkuId3”
      ],
      “pendingDeactivationSkuPartnerIds”: [“TestPartnerSkuId3”]
}
```

### JSON Response Example (Upgrade Available):

```
{
      “responseStatus”: “UPGRADE_AVAILABLE”,
      “responseMessage”: “Status updated successfully for Cloud
Instance having External ID:TestExternalId and an upgrade is available.”,
      “upgradeInformation”: {
            “maintenceStart”: “2014-07-30T15:53:50.450+0000”,
            “maintenceEnd”: “2014-07-30T18:53:50.450+0000”,
            “url”: “http://productUpgradeUrl”,
            “newVersion”: “2.0”
      },
      “activeSkuPartnerIds”: [
            “TestPartnerSkuId”,
            “TestPartnerSkuId2”,
            “TestPartnerSkuId3”
      ],
      “pendingDeactivationSkuPartnerIds”: [“TestPartnerSkuId3”]
}
```

The Bulk Toggle SKUs service operation allows products to activate or deactivate SKUs as necessary via a bulk submission. As customers' needs change they may seek to enable or disable certain features/SKUs within their account. In the event the product partner allows customers to manage SKUs directly within the product itself, the instance must notify CSM of the active SKUs. The changes should come in the form of a list of SKUs that are activated for the customer. All of the SKUs in the list will be marked as active.

CSM also lets users manage their product subscriptions from within the CSM graphical user interface, allowing users to turn features/SKUs on or off from within the GUI. For SaaS products, any feature/SKU changes that occur within the CSM Back Office are handled by sending an email to the SaaS product partner that a CSM user has requested enabling or disabling features within the SaaS subscription. Feature activation and deactivation requests from the CSM are acted upon as quickly as possible to reduce the possibility that conflicts arise.

CSM will not accept usage for any SKUs that it considers inactive. If the product allows users to enable or disable features/SKUs directly within the product's GUI, the product must to communicate all active SKUs via the Toggle SKUs service prior to submitting any SKU usage via the Usage Service.

Any SKUs that were previously active within CSM and then disabled through the CSM GUI or via the Toggle SKUs service operation will have a pending deactivation state in the response. The SKU will remain in the pending deactivation state until CSM receives usage details for the SKU, at which point the SKU will become inactive. Whenever a SKU enters the pending deactivation state, the product should prevent users from accessing the associated feature and incurring additional, unwanted usage charges.

The Bulk Toggle SKUs Service Operation requires one or more toggleSkusRequest to be sent via one of the presented interfaces in the form of a single toggleSkusBulkRequest. Each request requires a list of SKU IDs represented as Strings to reference the desired SKUs, which should be active on the target product instance specified via the external ID that is also to be included in the request. The following provide exemplary XML requests and responses using the SOAP web service protocol.

### XML Request Datatype:

```
<xs:complexType name=“toggleSkuActivationBulkRequest”>
      <xs:sequence>
            <xs:element name=“toggleSkusRequests”
type=“tns:toggleSkusRequest” maxOccurs=“unbounded”/>
      </xs:sequence>
</xs:complexType>
<xs:complexType name=“partnerMetricsServiceRequest”>
      <xs:sequence>
            <xs:element name=“externalId” type=“xs:string”/>
      </xs:sequence>
</xs:complexType>
<xs:complexType name=“toggleSkusRequest”>
      <xs:complexContent>
            <xs:extension base=“tns:partnerMetricsServiceRequest”>
                  <xs:sequence>
                        <xs:element name=“activeSkuIds”
type=“xs:string” nillable=“true” minOccurs=“0”
maxOccurs=“unbounded”/>
                  </xs:sequence>
            </xs:extension>
      </xs:complexContent>
</xs:complexType>
```

### XML Request Example:

```
<soapenv:Envelope xmlns:soapenv=“http://schemas.xmlsoap.org/soap/
envelope/” xmlns:ser=“http://soap.svc.metrics.partner.csm.leidos.com/”>
      <soapenv:Header/>
      <soapenv:Body>
            <soap:toggleSkuActivationBulkRequest>
                  <toggleSkusRequests>
                        <externalId>TestExternalId</externalId>
                        <activeSkuIds>TestPartnerSkuId
                        </activeSkuIds>
                        <activeSkuIds>TestPartnerSkuId2
                        </activeSkuIds>
                  </toggleSkusRequests>
                  <toggleSkusRequests>
                        <externalId>TestExternalId2</externalId>
                        <activeSkuIds>TestPartnerSkuId
                        </activeSkuIds>
                  <activeSkuIds>TestPartnerSkuId2</activeSkuIds>
            </toggleSkusRequests>
            </soap:toggleSkuActivationBulkRequest>
      </soapenv:Body>
</soapenv:Envelope>
```

### XML Response Type:

```
<xs:complexType name=“partnerMetricsServiceResponse”>
      <xs:sequence>
            <xs:element name=“responseMessage” type=“xs:string”/>
            <xs:element name=“responseStatus”
type=“tns:partnerMetricsServiceErrorType”/>
            <xs:element name=“ActiveSkusCollection”
type=“tns:activeSkusAggregate” maxOccurs=“unbounded”/>
      </xs:sequence>
</xs:complexType>
<xs:complexType name=“activeSkusAggregate”>
      <xs:sequence>
            <xs:element name=“externalId” type=“xs:string”/>
            <xs:element name=“ActiveSkuPartnerIds” type=“xs:string”
maxOccurs=“unbounded”/>
            <xs:element name=“PendingDeactivationSkuPartnerIds”
type=“xs:string” maxOccurs=“unbounded”/>
      </xs:sequence>
</xs:complexType>
```

### XML Response Status Types:

```
<xs:simpleType name=“partnerMetricsServiceErrorType”>
      <xs:restriction base=“xs:string”>
            <xs:enumeration value=“STALE_DATA”/>
            <xs:enumeration value=“NOT_FOUND”/>
            <xs:enumeration value=“SUCCESSFUL”/>
            <xs:enumeration value=“ERROR”/>
            <xs:enumeration value=“BAD_REQUEST”/>
            <xs:enumeration value=“UPGRADE_AVAILABLE”/>
      </xs:restriction>
</xs:simpleType>
```

### XML Response Example:

```
<S:Envelope xmlns:S=“http://schemas.xmlsoap.org/soap/envelope/”>
      <S:Body>
            <ns2:saveUsageDetailsResponse
xmlns:ns2=“http://soap.svc.metrics.partner.csm.leidos.com/”>
                  <ActiveSkusCollection>
                        <externalId>TestExternalId</externalId>
                        <ActiveSkuPartnerIds>TestPartnerSkuId</ActiveSkuPartnerIds>
                        <ActiveSkuPartnerIds>TestPartnerSkuId2</ActiveSkuPartnerIds>
                        <ActiveSkuPartnerIds>TestPartnerSkuId3</ActiveSkuPartnerIds>
                        <PendingDeactivationSkuPartnerIds>TestPartnerSkuId3</
PendingDeactivationSkuPartnerIds>
                  </ActiveSkusCollection>
                  <ActiveSkusCollection>
                        <externalId>TestExternalId2</externalId>
                        <ActiveSkuPartnerIds>TestPartnerSkuId</ActiveSkuPartnerIds>
                        <ActiveSkuPartnerIds>TestPartnerSkuId2</ActiveSkuPartnerIds>
                        <ActiveSkuPartnerIds>TestPartnerSkuId3</ActiveSkuPartnerIds>
                        <PendingDeactivationSkuPartnerIds>TestPartnerSkuId3</
PendingDeactivationSkuPartnerIds>
                  </ActiveSkusCollection>
                  <responseMessage>Update to desired SKUs activation status successful
for all Product Subscriptions.</responseMessage>
                  <responseStatus>SUCCESSFUL</responseStatus>
            </ns2:saveUsageDetailsResponse>
      </S:Body>
</S:Envelope>
```

The following provide exemplary JSON requests and responses using the REST web service protocol.

### JSON Request Type:

```
{
    “type”: “object”,
    “id”:
“urn:jsonschema:com:leidos:csm:partner:metrics:svc:model:
ToggleSkusBulkRequest”,
    “properties”: {
        “toggleSkusRequests”: {
            “type”: “array”,
            “items”: {
                “type”: “object”,
                “properties”: {
                    “externalId”: {
                        “type”: “string”,
                        “required”: true
                    },
                    “activeSkuIds”: {
                        “type”: “array”,
                        “items”: {
                            “type”: “string”
                        }
                    }
                }
            }
        }
    }
}
```

### JSON Request Example:

```
{
      “toggleSkusRequests”: [
      {
            “externalId”: “TestExternalId”,
            “activeSkuIds”: [
                  “TestPartnerSkuId”,
                  “TestPartnerSkuId2”
            ]
      },
      {
            “externalId”: “TestExternalId2”,
            “activeSkuIds”: [
                  “TestPartnerSkuId”,
                  “TestPartnerSkuId2”
            ]
        }
      ]
}
```

### JSON Response Example:

```
{
    “responseStatus”: “SUCCESSFUL”,
    “responseMessage”: “Usage Details submission successful”,
    “activeSkusAggregationCollection”: [
        {
          “externalId”: “TestExternalId”,
          “activeSkuPartnerIds”: [
              “TestPartnerSkuId”,
              “TestPartnerSkuId2”,
              “TestPartnerSkuId3”
          ],
          “pendingDeactivationSkuPartnerIds”: [“TestPartnerSkuId3”]
        },
        {
          “externalId”: “TestExternalId2”,
          “activeSkuPartnerIds”: [
              “TestPartnerSkuId”,
              “TestPartnerSkuId2”,
              “TestPartnerSkuId3”
          ],
          “pendingDeactivationSkuPartnerIds”: [“TestPartnerSkuId3”]
        }
    ]
}
```

The Bulk Usage service operation allows products to provide details about customer and SKU-specific usage via bulk submission. As companies select a vendor's product to be a part of their security architecture, the product must provide CSM with usage details for each specific customer and SKU. The usage details are a list of all the billable Stock Keeping Units (SKUs) within the given product that are active and generating usage. See above on Toggling SKUs for details on the message response provided by CSM.

In the event that one or more of the usage details submitted via this operation fail at any point along their processing, then they will be collected into a list of failedUsageDetails and appended to the response error message for examination. Those that are submitted and are not included in this list of failed usage details will have been successfully saved.

The Bulk Usage Service Operation requires one or more saveUsageDetailRequest to be sent via one of the presented interfaces in the form of a single saveUsageDetailsRequest.

Each request requires a SKU ID represented as a String to reference a single SKU for that particular, submitted Usage Detail. Each request also requires a float value indicating the usage of the SKU and two dates—a “from date” and a “to date”—which indicate the time period for the usage of the SKU (“fromDate”→“toDate”). The following provide exemplary XML requests and responses using the SOAP web service protocol.

### XML Request Datatype:

```
<xs:complexType name=“saveUsageDetailsRequest”>
    <xs:sequence>
        <xs:element name=“saveUsageDetailRequests”
type=“tns:saveUsageDetailRequest” maxOccurs=“unbounded”/>
    </xs:sequence>
</xs:complexType>
<xs:complexType name=“partnerMetricsServiceRequest”>
    <xs:sequence>
        <xs:element name=“externalId” type=“xs:string”/>
    </xs:sequence>
</xs:complexType>
<xs:complexType name=“saveUsageDetailRequest”>
    <xs:complexContent>
        <xs:extension base=“tns:partnerMetricsServiceRequest”>
            <xs:sequence>
                <xs:element name=“fromDate” type=“xs:dateTime”/>
                <xs:element name=“skuId” type=“xs:string”/>
                <xs:element name=“toDate” type=“xs:dateTime” />
                <xs:element name=“usage” type=“xs:float”/>
            </xs:sequence>
        </xs:extension>
    </xs:complexContent>
</xs:complexType>
```

### XML Request Example:

```
<soapenv:Envelope xmlns:soapenv=“http://schemas.xmlsoap.org/soap/
envelope/” xmlns:soap=“http://soap.svc.metrics.partner.csm.leidos.com”>
    <soapenv:Header/>
    <soapenv:Body>
        <soap:saveUsageDetailsRequest>
            <saveUsageDetailRequests>
                <externalId>TestExternalId</externalId>
                <fromDate>2013-10-26T21:32:52.000+0000
                </fromDate>
                <skuId>TestPartnerSkuId</skuId>
                <toDate>2014-10-26T21:32:52.000+0000</toDate>
                <usage>100</usage>
            </saveUsageDetailRequests>
            <saveUsageDetailRequests>
                <externalId>TestExternalId</externalId>
                <fromDate>2014-10-26T21:32:52.000+0000
                </fromDate>
                <skuId>TestPartnerSkuId</skuId>
                <toDate>2014-11-26T21:32:52.000+0000</toDate>
                <usage>100</usage>
            </saveUsageDetailRequests>
        </soap:saveUsageDetailsRequest>
    </soapenv:Body>
</soapenv:Envelope>
```

### XML Response Type:

```
<xs:complexType name=“partnerMetricsServiceResponse”>
    <xs:sequence>
        <xs:element name=“responseMessage” type=“xs:string”/>
        <xs:element name=“responseStatus”
type=“tns:partnerMetricsServiceErrorType”/>
    </xs:sequence>
</xs:complexType>
```

### XML Response Status Types:

```
<xs:simpleType name=“partnerMetricsServiceErrorType”>
    <xs:restriction base=“xs:string”>
        <xs:enumeration value=“STALE_DATA”/>
        <xs:enumeration value=“NOT_FOUND”/>
        <xs:enumeration value=“SUCCESSFUL”/>
        <xs:enumeration value=“ERROR”/>
        <xs:enumeration value=“BAD_REQUEST”/>
        <xs:enumeration value=“UPGRADE_AVAILABLE”/>
    </xs:restriction>
</xs:simpleType>
```

### XML Response Example:

```
<S:Envelope xmlns:S=“http://schemas.xmlsoap.org/soap/envelope/”>
    <S:Body>
        <ns2:saveUsageDetailsResponse
xmlns:ns2=“http://soap.svc.metrics.partner.csm.leidos.com”>
            <responseMessage>Usage Details submission successful
            </responseMessage>
            <responseStatus>SUCCESSFUL</responseStatus>
        </ns2:saveUsageDetailsResponse>
    </S:Body>
</S:Envelope>
```

The following provide exemplary JSON requests and responses using the REST web service protocol.

### JSON Request Type:

```
{
    “type”: “object”,
    “id”:
“urn:jsonschema:com:leidos:csm:partner:metrics:svc:model:
SaveUsageDetailsRequest”,
    “properties”: {
        “saveUsageDetailRequests”: {
            “type”: “array”,
            “items”: {
                “type”: “object”,
                “properties”: {
                    “externalId”: {
                        “type”: “string”,
                        “required”: true
                    },
                    “fromDate”: {
                        “type”: “string”,
                        “format”: “date-time”,
                        “required”: true
                    },
                    “skuId”: {
                        “type”: “string”,
                        “required”: true
                    },
                    “usage”: {
                        “type”: “number”,
                        “minimum”: 0,
                        “required”: true
                    },
                    “toDate”: {
                        “type”: “string”,
                        “format”: “date-time”,
                        “required”: true
                    }
                }
            }
        }
    }
}
```

### JSON Request Example:

```
{
    “saveUsageDetailRequests”: [
    {
        “externalId”: “TestExternalId”,
        “skuId”: “TestPartnerSkuId”,
        “fromDate”: “2014-08-20T16:47:35.494+0000”,
        “toDate”: “2014-08-25T16:47:35.494+0000”,
        “usage”: 47
    },
    {
        “externalId”: “TestExternalId”,
        “skuId”: “TestPartnerSkuId”,
        “fromDate”: “2014-08-25T16:47:35.494+0000”,
        “toDate”: “2014-09-10T16:47:35.494+0000”,
        “usage”: 84
    }
    ]
}
```

### JSON Response Example:

```
{
    “responseStatus”: “SUCCESSFUL”,
    “responseMessage”: “Usage Details submission successful”
}
```

The Instance Security Assessment service operation allows partners to provide a security assessment, as determined by their product, within a given customer's product instance. Assessments can be relayed one at a time and will target vendor-specified custom security categories, for example “Password Strength” or “Password Maintenance”. Each assessment can contain one or more recommendations that suggest SKUs to the customer that may aid them in dealing with their perceived security problems, as well as the rationale behind making the recommendation.

The Instance Security Assessment Service Operation requires one securityAssessmentRequest to be sent via one of the presented interfaces. Each request requires an Instance ID represented as a String to reference a single customer's instance for that particular, submitted Security Assessment. Each request also requires an integer value from 0-100 indicating the score of the assessment and a String referencing the security category that the assessment is pertaining to. As an aid to the end user's understanding of the security assessment, a String for the security assessment's description has been provided for vendors to elaborate on the category specified and the means used to determine the given score. Furthermore, one can include a list of SecurityRecommendation objects that include a single String field explaining the rationale behind that recommendation and a list of Strings representing the Partner IDs of recommended SKUs that would help complement that recommendation. The following provide exemplary XML requests and responses using the SOAP web service protocol.

### XML Request Datatype:

```
<xs:complexType name=“partnerMetricsServiceRequest”>
    <xs:sequence>
        <xs:element name=“externalId” type=“xs:string”/>
    </xs:sequence>
</xs:complexType>
<xs:complexType name=“securityAssessmentRequest”>
    <xs:complexContent>
        <xs:extension base=“tns:partnerMetricsServiceRequest”>
            <xs:sequence>
                <xs:element name=“category” type=“xs:string”/>
                <xs:element name=“description” type=“xs:string”/>
                <xs:element name=“recommendations”
type=“tns:securityRecommendation” nillable=“true” minOccurs=“0”
maxOccurs=“unbounded”/>
                <xs:element name=“score” type=“xs:int” min=”0”
                max=”100”/>
            </xs:sequence>
        </xs:extension>
    </xs:complexContent>
</xs:complexType>
<xs:complexType name=“securityRecommendation”>
    <xs:sequence>
        <xs:element name=“rationale” type=“xs:string”/>
        <xs:element name=“skuIds” type=“xs:string” nillable=“true”
minOccurs=“0” maxOccurs=“unbounded”/>
    </xs:sequence>
</xs:complexType>
```

### XML Request Example:

```
<soapenv:Envelope xmlns:soapenv=“http://schemas.xmlsoap.org/soap/
envelope/” xmlns:ser=“http://soap.svc.metrics.partner.csm.leidos.com”>
    <soapenv:Header/>
    <soapenv:Body>
        <soap:saveSecurityAssessmentRequest>
            <externalId>TestExternalId</externalId>
            <category>Password Strength</category>
            <description>XYZ Corp evaluates the degree of compliance
with best practice password complexity standards</description>
            <score>25</score>
            <recommendations>
                <rationale>Weak Password</rationale>
                <skuIds>TestPartnerSkuId</skuIds>
                <skuIds>TestPartnerSkuId2</skuIds>
            </recommendations>
        </soap:saveSecurityAssessmentRequest>
    </soapenv:Body>
</soapenv:Envelope>
```

### XML Response Status Types:

```
<xs:simpleType name=“partnerMetricsServiceErrorType”>
    <xs:restriction base=“xs:string”>
        <xs:enumeration value=“STALE_DATA”/>
        <xs:enumeration value=“NOT_FOUND”/>
        <xs:enumeration value=“SUCCESSFUL”/>
        <xs:enumeration value=“ERROR”/>
        <xs:enumeration value=“BAD_REQUEST”/>
        <xs:enumeration value=“UPGRADE_AVAILABLE”/>
    </xs:restriction>
</xs:simpleType>
```

### XML Response Status Types:

```
<S:Envelope xmlns:S=“http://schemas.xmlsoap.org/soap/envelope/”>
    <S:Body>
        <ns2:saveUsageDetailsResponse xmlns:ns2=
        “http://server.csm.leidos.com”>
            <responseMessage>Security assessment submission
successful for Product Instance having External ID: TestExternalId
</responseMessage>
            <responseStatus>SUCCESSFUL</responseStatus>
        </ns2:saveUsageDetailsResponse>
    </S:Body>
</S:Envelope>
```

The following provide exemplary JSON requests and responses using the REST web service protocol.

### JSON Request Type:

```
{
    “type”: “object”,
    “id”:
“urn:jsonschema:com:leidos:csm:securityassessments:svc:model:
SecurityAssessmentRequest”,
    “properties”: {
        “externalId”: {
            “type”: “string”,
            “required”: true
        },
        “category”: {
            “type”: “string”,
            “required”: true
        },
        “description”: {
            “type”: “string”,
            “required”: true
        },
        “score”: {
            “type”: “integer”,
            “minimum”: 0,
            “maximum”: 100,
            “required”: true
        },
        “recommendations”: {
            “type”: “array”,
            “required”: false,
            “items”: {
                “type”: “object”,
                “properties”: {
                    “rationale”: {
                        “type”: “string”,
                        “required”: true
                    },
                    “skuIds”: {
                        “type”: “array”,
                        “required”: false,
                        “items”: {
                            “type”: “string”
                        }
                    }
                }
            }
        }
    }
}
```

### JSON Request Example:

```
{
    “externalId”: “TestExternalId”,
    “category”: “Password Strength”,
    “description”: “XYZ Corp evaluates the degree of compliance with
best practice password complexity standards”,
    “score”: 25,
    “recommendations”: [
        {
            “rationale”: “Weak Password”,
            “skuIds”: [
                “TestPartnerSkuId”,
                “TestPartnerSkuId2”
            ]
        }
    ]
}
```

### JSON Response Example:

```
{
    “responseStatus”: “SUCCESSFUL”,
    “responseMessage”: “Security assessment submission successful
for Product Instance having External ID: TestExternalId”
}
```

The Instance Action Alert service operation allows partners to provide their customers with simple action alerts, which pertain to information that is reported by the customers' product instances. These alerts take the form of a simple text-based message and can only be submitted one at a time. Each of these alerts ties specifically to a single, dedicated product instance, whereby the user can access and view the alerts via the widgets they have displayed on their dashboard.

The Instance Action Alert Service Operation requires one InstanceActionAlert object to be sent via one of the presented interfaces. Each alert requires an Instance ID represented as a String to reference a single customer's instance for that particular, submitted Instance Alert. The alert also requires a message that will be relayed to the customer, and which also takes the form of a String. The following provide exemplary XML requests and responses using the SOAP web service protocol.

### XML Request Datatype:

```
<xs:complexType name=“saveInstanceActionAlertRequest”
type=“tns:instanceActionAlertRequest”>
<xs:complexType name=“instanceActionAlertRequest”>
    <xs:complexContent>
        <xs:extension base=“tns:partnerMetricsServiceRequest”>
            <xs:sequence>
                <xs:element name=“alert” type=“xs:string”/>
            </xs:sequence>
        </xs:extension>
    </xs:complexContent>
</xs:complexType>
<xs:complexType name=“partnerMetricsServiceRequest”>
    <xs:sequence>
        <xs:element name=“externalId” type=“xs:string”/>
    </xs:sequence>
</xs:complexType>
```

### XML Request Example:

```
<soapenv:Envelope xmlns:soapenv=“http://schemas.xmlsoap.org/soap/
envelope/”
xmlns:soap=“http://soap.svc.metrics.partner.csm.leidos.com/”>
    <soapenv:Header/>
    <soapenv:Body>
        <soap:saveInstanceActionAlertRequest>
            <externalId>TestExternalId</externalId>
            <alert>Your password will expire in 5 days.</alert>
        </soap:saveInstanceActionAlertRequest>
    </soapenv:Body>
</soapenv:Envelope>
```

### XML Response Status Types:

```
<xs:simpleType name=“partnerMetricsServiceErrorType”>
    <xs:restriction base=“xs:string”>
        <xs:enumeration value=“STALE_DATA”/>
        <xs:enumeration value=“NOT_FOUND”/>
        <xs:enumeration value=“SUCCESSFUL”/>
        <xs:enumeration value=“ERROR”/>
        <xs:enumeration value=“BAD_REQUEST”/>
        <xs:enumeration value=“UPGRADE_AVAILABLE”/>
    </xs:restriction>
</xs:simpleType>
```

### XML Response Example:

```
<S:Envelope xmlns:S=“http://schemas.xmlsoap.org/soap/envelope/”>
    <S:Body>
        <ns2:saveUsageDetailsResponse xmlns:ns2=
        “http://server.csm.leidos.com”>
            <responseMessage>Alert action submission successful for
Product Instance having External ID: TestExternalId</responseMessage>
            <responseStatus>SUCCESSFUL</responseStatus>
        </ns2:saveUsageDetailsResponse>
    </S:Body>
</S:Envelope>
```

The following provide exemplary JSON requests and responses using the REST web service protocol.

### JSON Request Type:

```
{
    “type”: “object”,
    “id”: “urn:jsonschema:com:leidos:csm:domain:model:
    InstanceActionAlertRequest”,
    “properties”: {
        “externalId”: {
            “type”: “string”,
            “required”: true
        },
        “alert”: {
            “type”: “string”,
            “required”: true
        }
    }
}
```

### JSON Request Example:

```
{
    “externalId”: “TestExternalId”,
    “alert”: “Your password will expire in 5 days.”
}
```

### JSON Response Example:

```
{
    “responseStatus”: “SUCCESSFUL”,
    “responseMessage”: “Alert action submission successful for
Product Instance having External ID: TestExternalId”
}
```

Exception handling is different for each interface of the Partner Metrics Service. The following sections detail how each interface handles exceptions or errors and communicates them back to developers. There are two possible causes of SOAP faults:
1. Caused by problems with the values submitted during validation of the data.
2. Caused by a problem in validating the required Authorization HTTP header
   The following is an example of a SOAP fault returned because there was something wrong with the information in the request:
   Request with a Bad Instance Id:

```
<soapenv:Envelope xmlns:soapenv=“http://schemas.xmlsoap.org/soap/
envelope/”
xmlns:ser=“http://server.csm.leidos.com”>
    <soapenv:Header/>
    <soapenv:Body>
        <ser:saveUsageDetailRequest>
            <externalId>BadExternalId</externalId>
            <fromDate>2014-10-26T21:32:52</fromDate>
            <skuId>TestSkuId</skuId>
            <toDate>2015-10-26T21:32:52</toDate>
            <usage>45.6</usage>
        </ser:saveUsageDetailRequest>
    </soapenv:Body>
</soapenv:Envelope>
```

### Response:

```
<S:Envelope xmlns:S=“http://schemas.xmlsoap.org/soap/envelope/”>
    <S:Body>
        <ns2:saveUsageDetailResponse
xmlns:ns2=“http://soap.svc.metrics.partner.csm.leidos.com”>
            <responseMessage>Attempt to save usage detail failed,
the following error occurred: The given external ID is invalid. No Product
Subscription was found for the ID: BadExternalId</responseMessage>
            <responseStatus>ERROR</responseStatus>
        </ns2:saveUsageDetailResponse>
    </S:Body>
</S:Envelope>
```

The following is an example of a SOAP fault being returned because there is something wrong with the validity of the authorization header:

### CSM-Authorization: TestExternalId:WrongTestProvidedAccessToken

Request: Doesn't matter, the request will fail because of the bad HTTP header.

### Response:

### HTTP/1.1 401 Unauthorized

Content-Type: text/html;charset=ISO-8859-1
Cache-Control: must-revalidate,no-cache,no-store

### Content-Length: 1404

Server: Jetty(8.1.14.v20131031)

There are only four possible causes of the REST services returning anything other than a 200 Level HTTP Response (HTTP Responses in the 200's are generally accepted as “good”):
1. HTTP Status 400: BAD_REQUEST caused by a problem with the structure or data types of the fields in the request JSON
2. HTTP Status 400: BAD_REQUEST caused by a problem while validating the data in the request JSON
3. HTTP Status 401: UNAUTHORIZED caused by a problem in validating the required

Authorization HTTP header
4. HTTP Status 404: NOT_FOUND caused by a missing resource or a bad path.
   The following example illustrates where POST requests are sent to the usage details resource: /rest/partnerMetricsService/cloudSubscriptions/TestExternalId/usageDetails.
   The following is an example of a HTTP 400 Status where something was wrong with the structure or data types of the fields in the request:
   Request with a String value for usage, instead of a float:

```
{
    “fromDate”:“2014-08-20T16:47:35.494+0000”,
    “toDate”:“2014-08-25T16:47:35.494+0000”,
    “skuId”:“TestSkuId”,
    “usage”:“NotAFloat”
}
```

### Response:

### HTTP/1.1 400 Bad Request

Content-Type: text/html

### Content-Length: 329

Server: Jetty(8.1.12.v20130726)
com.fasterxml.jackson.databind.exc.InvalidFormatException: Can not construct instance of java.lang.Float from String value ‘NotAFloat’: not a valid Float value
at [Source: org.eclipse.jetty.server.HttpInput@3f6225b8; line: 4, column: 21] (through reference chain: com.leidos.csm.partner.service.model.SaveUsageDetailRequest[“usage”])
The following is an example of a HTTP 400 Status because of an invalid data in the request JSON:
Request with an invalid SKU ID field:

```
{
    “fromDate”:“2014-08-20T16:47:35.494+0000”,
    “toDate”:“2014-08-25T16:47:35.494+0000”,
    “partnerSkuId”:“BadPartnerSkuId”,
    “usage”:“45.6”
}
```

### Response:

### HTTP/1.1 400 Bad Request

### Content-Length: 211

Content-Type: application/json
Server: Jetty(8.1.14.v20131031)
{“responseStatus”:“ERROR”,“responseMessage”:“Attempt to save usage detail failed, the following error occurred: Partner SKU ID: BadPartnerSkuId is invalid for the product subscription found for: TestExternalId”}

```
{
    “responseStatus”:“ERROR”,
    “responseMessage”:“Attempt to save usage detail failed, the
following error occurred: Partner SKU ID: BadPartnerSkuId is invalid for
the product subscription found for: TestExternalId”
}
```

The following is an example of HTTP 401 status caused by using an invalid Authorization header for the HTTP request: CSM-Authorization:

### TestExternalId:WrongTestProvidedAccessToken

Request: Doesn't matter, the request will fail because of the bad HTTP header.

### Response:

### HTTP/1.1 401 Unauthorized

Content-Type: text/html;charset=ISO-8859-1
Cache-Control: must-revalidate,no-cache,no-store

### Content-Length: 1449

Server: Jetty(8.1.2.v20120308)
The following is an example of HTTP 404 status caused by using bad URL when POSTing to:
/rest/partnerMetricsService/cloudSubscriptions/TestExternalId/usageDetail
Request: Doesn't matter, the request will fail because of the bad URL

### Response:

### HTTP/1.1 404 Not Found

Content-Type: text/html;charset=ISO-8859-1
Cache-Control: must-revalidate,no-cache,no-store

### Content-Length: 1444

Server: Jetty(8.1.12.v20130726)

CSM accomplishes SSO to customer subscriptions (both VM instances and SaaS services) by leveraging the Security Assertion Markup Language (SAML) SSO protocol in the form of an identity provider (IDP) Initiated scenario using HTTP POST Binding. IDP Initiated means that CSM will not accept any <saml:AuthnRequest> for authentication as an IDP would in an SP Initiated scenario, but instead will send a <saml:Response> to instances for customers who are already logged into the platform.

CSM uses SAML Post Binding in a preferred embodiment because of its common use in the industry and the ease of support. Post binding transports the <saml:Response> to an ISV's subscription instance by posting a form to an HTTP Endpoint. The form payload will be a single field called “SAMLResponse”, which contains 64 bit encoded X.509 signed <saml:Assertion> in a <saml:Response>. the <saml:Assertion> element contains the following child elements:
A <ds:Signature> element, which contains an integrity-preserving digital signature over the <saml:Assertion> element
A <saml:Subject> element, which identifies the authenticated principal via the CSM user's email address as NameID
A <saml:Conditions> element, which gives the conditions under which the assertion is to be considered valid
A <saml:AuthnStatement> element, which describes the act of authentication at the identity provider

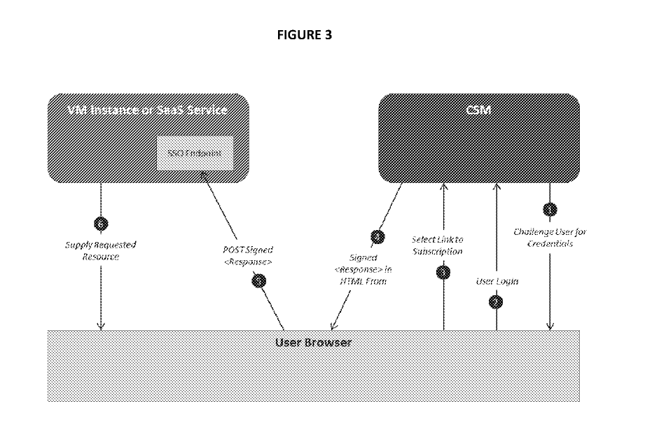

Referring to FIG. 3, the schematic illustrates the key process features 1 to 8 of SSO user log-in to customer subscriptions as discussed above.

The CSM adheres to a consumption-based usage model across the entire portfolio of vendor products. As such, the CSM can support various degrees of usage-level reporting from vendor products, which form the basis for customer billing and vendor invoicing as discussed further below. As discussed previously, the CSM implements a common set of defined web service interfaces (APIs). Vendors may choose to implement the defined APIs in order to report usage at the application level (e.g., number of events handled, etc.) as well as the individual capability level. The CSM will ingest these usage metrics, via the defined API response, and associate the usage with the corresponding customer.

For those vendors that choose not to implement the defined APIs, the CSM includes that ability to generate basic usage metrics via each product instance's hypervisor. This implementation will report usage metrics in terms of the uptime (e.g., number of VM hours) of each instance over a user-defined period of time. This allows simple, initial integration of products with little upfront development.

The defined APIs provide mechanisms to track and detect unauthorized product instances. Through the use of a defined heartbeat API provided by the CSM platform, a deployed instance knows that it is legitimate and should continue to operate. Those product instances that are started through unauthorized means will not receive the heartbeat from the CSM and will then self-disable in a fail secure means. The actual means of failing secure is left to the product vendor but ideally leaves the network protected, but in an in-administrative state. By using the defined APIs and heartbeats, the vendors are liberated from having to engineer and operate their own licensing platform. This allows a vendor to bring its products into the cloud era of pay-per-use billing without standing up all the associated operational infrastructure (people, processes and equipment).

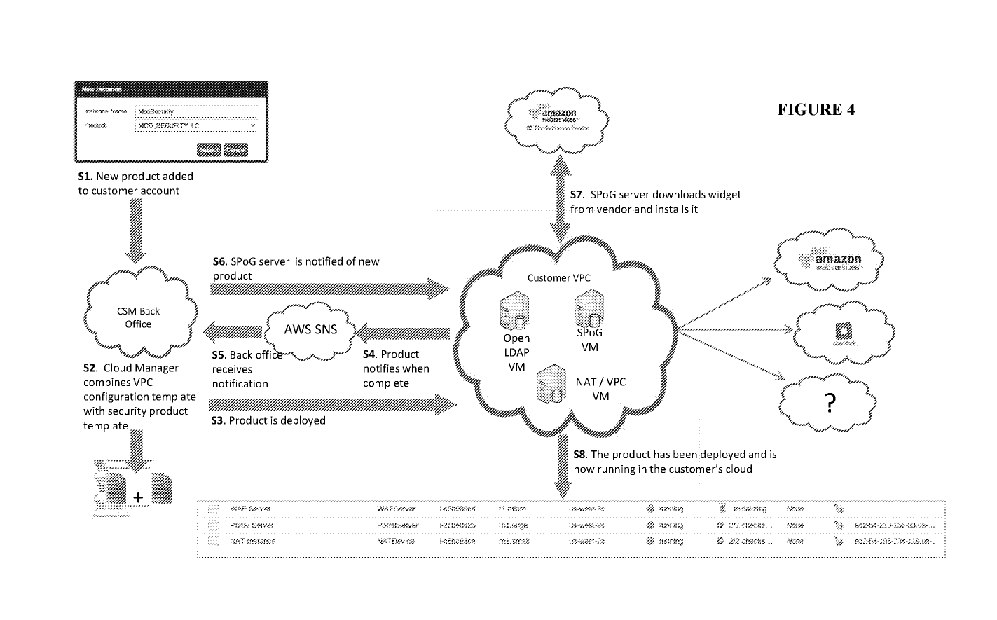

FIG. 4 is a schematic showing an exemplary new vendor product deployment within a CSM customer's VPC. The process includes the following general steps:

S1. New product added to customer account;
S2. CSM Cloud Manager combines VPC configuration template with security product template;
S3. Product is deployed to VPC;
S4. Product notifies CSM when complete, e.g., using AWS's Simple Notification Service (SNS);
S5. CSM Back office receives notification;
S6. SPoG server is notified of new product;
S7. SPoG server downloads widget from vendor and installs it; and
S8. The product has been deployed and is now running in the customer's cloud.

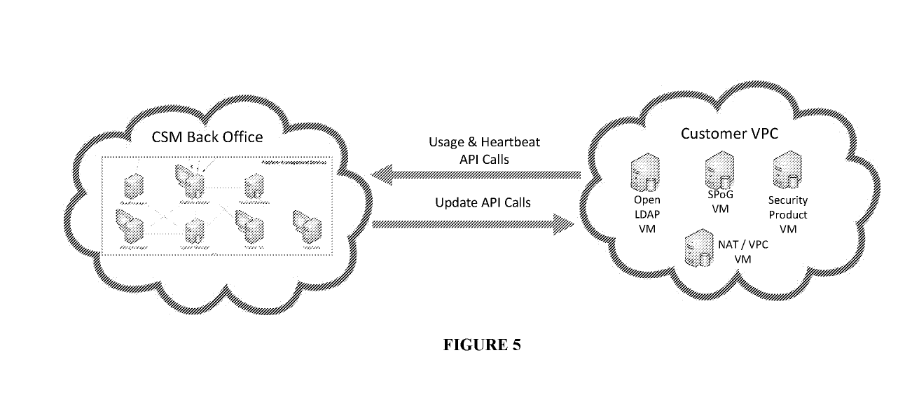

FIG. 5 is a schematic illustrating the heartbeat API calls between the CMS Back Office and the customer VPC after the security product has been provisioned. As discussed above, product instances that are started through unauthorized means will not receive the heartbeat from the CSM and will then self-disable in a fail secure means.

For customers electing to provision virtualized Security Incident and Event Management (SIEM) products into their VPC and who choose to utilize a Managed Security Service Provider (FIG. 1), the CSM platform will automatically configure the virtualized SIEM to direct its processed outputs directly to the selected Managed Security Service's Security Operations Center. The Security Operations Center provides security event monitoring for customers and acts to mitigate and remediate cyber threats quickly. In addition, the Security Operations Center can help customers tailor and customize security product configurations based on their specific business needs and concerns.

More particularly, when customers register on the CSM, they are immediately provisioned with their own dedicated web-based Customer Security Portal or dashboard (FIGS. 1; 14), which provides them with a ‘single pane of glass’ (SPoG) view into their specific security posture. The Customer Security Portal 14 includes a series of portlets that interact with each of the customer's provisioned security product instances 12ₐ₋ₓ and provides customers with immediate insight into key security events affecting their digital assets, i.e., network and protected applications. The Customer Security Portal 14 provides a consistent look and feel across all product portlets in accordance with specifications contained within the Security platform.

This security event information is also aggregated by the CSM, facilitating pivoted views across various axis and allowing customers to examine their enterprise risk in different manners than simply by individual security product. FIG. 2 provides an example of one such view in the form of an enterprise risk heat map which showcases a company's applications and data stores by value and by security coverage. Value can be defined as the liability should the application be compromised (e.g., downtime, loss of revenue, lawsuit liability, regulatory fines, etc) and security coverage, including the existence and correct setup and operations of the security products and controls for the application. These enterprise views showcase the complete enterprise security situation in a single graphical format allowing for rapid identification of outlier issues.

In the VPC, it becomes trivial for new business applications to be provisioned and turned on, e.g., by employees, often times without the knowledge of the organization's information technology security personnel. This leads to new business risk as these applications may hold valuable information and yet don't have the appropriate security products and controls in place. The CSM interfaces with the VPC to identify these new business application, make the customer aware of the threat and make recommendations for a proposed course of action. This information is provided via the Customer Security Portal.

Through the Customer Security Portal, a graphical map of the customer's application showcases the various user populations and data paths in and out of each application and data store. This allows the customer to identify unauthorized user populations and validate that those data paths in place have the adequate security products and controls. Each data path shows the Service Chain of security products and controls in place for the data path. The CSM allows the customer to define the generic Service Chain required for each type of data path (i.e. Internet to a public website, trusted partner to a protected/privileged data store, etc.). The CSM then applies the appropriate customer-defined Service Chain and showcases the information on the Customer Security Dashboard.

In addition to the security event reporting capabilities provided by each of the portlets, the Customer Security Portal provides customers and authorized security operations specialists with direct access into the actual security products themselves without having to re-authenticate the user's credentials. This feature gives customers or managed security service specialists the ability to customize security product configurations in response to emerging cyber threats, access more detailed reports provided via the native application's management console, or enable additional capabilities associated with the security product.

The Customer Security Portal also serves as the customer-facing marketing venue to present new products and available product capabilities in a manner that is consistent with the customer's unique enterprise characteristics and product usage patterns. By mixing in the recommendations into this portal, the recommendations are constantly in the customers view.

Through the CMS's web-based vendor portal, each vendor maintains their own product information, including product capabilities, training materials (e.g., videos), targeted customer demographics (e.g., industries, size), applicable software stacks, compliance/regulatory capabilities, and wholesale pricing for each billable capability and usage metric. Tagging new products and capabilities with specific attributes allows the CSM to intelligently promote applicable products and capability upgrades to the appropriate customers via the recommendation engine.

In addition to managing products and product capabilities, the vendor portal provides a robust, vendor-specific view into each of the vendor's products through the dynamic display of product and capability usage along with a snapshot of active product instances across all supported cloud platforms. Each vendor can utilize the visualization and reporting features of the vendor portal to analyze usage data down to the level of individual product capabilities to help gauge customer adoption and better inform the vendor's internal product development decisions.

The CSM includes an update management component responsible for coordinating the scheduling and installation of new vendor-provided releases to existing security products. After a new product version is tested and brought onto the CSM, the update manager automatically identifies all active instances, across all customers, running the out-dated product version. The update manager triggers an automatic notification to each impacted customer's Customer Security Portal instance. The notification informs the customer of the new release, provides information associated with the new release capabilities, and identifies any price differences between their existing product and the newer version. Customers electing to install the new product version can select the desired date and time for updating their product version, at which point the Security platform will automatically execute the product update on behalf of the customer.

CSM back office personnel can access the CSM monitoring capability to view a situational awareness display for all active security product instances provisioned on behalf of all customers across all supported cloud platforms. Through this display, authorized personnel can view the health and status of each application, including the current resource utilization of each application. Users are immediately alerted to reported errors or utilization metrics that exceed pre-defined thresholds, allowing users to intervene on behalf of the customer by performing basic troubleshooting functions on the virtual instance or recommending to the respective customer specific product upgrades in response to increased demand through their network.

The CSM provides an interface for authorized platform operations team to enter and modify the retail pricing across all SKUs. This includes sufficient flexibility to support customer-specific pricing as well as volume based discount pricing on a customer-by-customer basis.

Authorized CSM operators can use the CSM to view usage and billing reports across customer, vendor, products or individual SKUs. When accessing customer billing statements, the CSM will apply the persisted unit-level retail pricing to the measured product and capability usage data to establish an itemized billing statement. When accessing vendor invoices, the platform will apply the persisted unit-level wholesale pricing to the measured product and capability usage data for all of the vendor's provisioned products (across all customers and cloud platforms) to establish an itemized vendor invoice. Statements and invoices will be exportable into a delimited format to be feed into accounts payable and accounts receivable systems. This CSM portal is also used by the security operations and sales teams to generate per customer recommendations. The recommendation report focuses in on additional product usage of an already deployed product and new product capabilities that a customer requires to improve the customer's security posture. The sales recommendation report focuses in on completely new products that would improve the customer's security posture. Since a completely new product installation is a much higher touch point, it may be handed off to the sales team. The security operations team focuses in on smaller individual product capability and usage growth.

Through the onboarding process, each vendor product is broken down by the CSM into functional and marketable system capabilities, assigned a globally unique SKU and loaded into the CSM's security portfolio along with recommendation engine attributes associated therewith and wholesale pricing. Each product is made up of a number of individual SKUs representing individually consumable and marketable products and product capabilities. The final step in the process is the tailoring of the training materials, product documentation and sales materials to load into the system.

Each product is taken through the platform proving grounds before being introduce into a production network. This proving ground testing validates that all the required interfaces have been implemented and are functioning correctly.

A core CSM capability is the usage and billing reports created from the usage data gathered by the system. This information may be processed and results in invoices and payments handled by the CSM financial team. This team handles the financial operations including the payment, invoicing, collections and reconciliation between the platform operator and the product vendors. The platform operator is billed for the aggregate product usage across all SKUs at the wholesale level and the product vendors are paid for product usage across all their individual SKUs. The CSM operator is responsible for the billing of each individual customer using the retailed pricing based billing reports generated by the platform.

Each vendor is responsible for providing a products to be integrated and offered across the platform. Each product is made available across the platform in a number of different virtual machine images and sizes. Based upon the customer's infrastructure (cloud technology) and anticipated workload, the appropriate image is deployed. The vendor is responsible for providing all of the product images so they are available to be deployed as needed. Each product image is a fully contained virtual machine (VM) image consisting of an operating system, application and interfaces to the platform.

Each vendor product has a number of technical flavors, each represented as a product image.

| Product | Image Name | Cloud Tech | Size | Capacity |
|---|---|---|---|---|
| Acme WAF | Acme-WAF- | AWS | M1.medium | 500 |
| | AWS-M | | | hits/second |
| Acme WAF | Acme-WAF- | AWS | M1.large | 2000 |
| | AWS-L | | | hits/second |
| Acme WAF | Acme-WAF- | OpenStack | M1.medium | 600 |
| | OS-M | | | hits/second |
| Acme WAF | Acme-WAF- | OpenStack | M1.large | 2400 |
| | OS-L | | | hits/second |

Within each product are a number of SKUs that a customer can use and be charged each for a specific business need. Each product instance tracks the SKU usage and passes this information onto the platform (via the usage API) for customer invoicing and vendor payment.

The vendor manages the product SKUs via the platform vendor portal. This includes adding new SKUs, managing pricing, managing recommendation engine attributes for the SKU and maintain training and marketing material for the SKU.

When a new SKU is introduced, the product is updated with the new capability and ability to track and report on the new SKU. The vendor needs to input this same information into the portal so it is aware of the new SKU when SKU usage information starts arriving.

| Product | SKU | Description | Units | Wholesale | Retail |
|---|---|---|---|---|---|
| Acme WAF | 1 | Learning | No Charge | $0 | $0 |
| | | Mode | | | |
| Acme WAF | 2 | Base | Per App/Hour | $5 | $10 |
| | | Usage | | | |
| Acme WAF | 3 | OWASP | Per App/Hour | $5 | $10 |
| | | Top 10 | | | |
| Acme WAF | 4 | Change | Per App/Hour | $1 | $2 |
| | | Mgmt. | | | |
| Acme WAF | 5 | PCI Audit | Per Execution | $500 | $1000 |
| | | Report | | | |

Through the vendor portal, the vendor keeps the SKUs associated with each product up to date. As the product is updated with new capabilities and the associated SKUs are created, they are then made available to customers. Customers can then upgrade their products, if required, and enable the new SKUs.

The vendor is also responsible for managing the wholesale price of each SKU as well as the recommendation engine metadata about each SKU. This information is used by the recommendation engine to promote the SKUs to each customer. Through the vendor portal, the vendor uploads any training, marketing and technical documentation materials associated with each SKU. Vendors are free to update their SKUs at any time. The CSM owner is partially responsible for SKU management as well. Specifically, the CSM owner is responsible for setting the retail price for each SKU either as a markup percentage or a fixed markup from the wholesale price.

Vendors manage the existing products through the vendor portal. This includes any upgrades to products (i.e. to rollout new software to enable new SKUs in their products). As product upgrades are made available by the vendor, the recommendation engine promotes those upgrades to customers who decide when to deploy an upgrade. Vendors are responsible for providing metadata associated with each upgrade so that the recommendation engine can promote the upgrade.

When an upgrade is deployed into a running customer instance, there is no incremental revenue until the SKUs associated with the upgrade are purchased by the customer. The upgrade simply enables the running product instance to now have the ability to offer additional SKUs which the customer may then decide to purchase. Of course, the upgrade may offer some non SKU related features (i.e. bug fixes).

In a continual capacity, the recommendation engine is updated with additional information about the customer. This can include new regulatory compliance requirements that the customer now falls under, new applications the customer is running or other changes that would drive the recommendation engine.

The recommendation engine may recommend deploying a new product in a learning mode onto the customer's network. In a learning mode, the device works in a passive mode feeding information back to the recommendation engine of what product SKUs should be enabled. Running the product in a learning mode is a non-revenue generating activity. Instead, it is a means to show the customer the value of the product. Even once the SKUs in that product are enabled and revenue is realized, the product always continues to feed information to the recommendation engine.

Through the customer's portal, products and SKUs are recommended to the customer. Training, marketing and documentation materials can be pulled up via the customer's portal to learn more about the product and specific SKUs. Through the portal, the customer can request the new product, which would drive a provisioning process or enable a new SKU, which the customer can do themselves through the product's interface.

Enabling SKUs within a product can be handled directly by the customer within the products. This is a revenue generating activity as a new SKU has direct charges that show up on the customer's monthly bill. The goal of the system is to expose the customer to information about the SKUs and then get those SKUs enabled.

As part of a back office function, invoices are generated and sent to customers (Accounts Receivable). These invoices are based upon the usage metered across the applications and services used across the platform. Usage line items per customer are fed into an enterprise accounts receivable (AR) system which in turn generates the invoices to send out to customers. The AR system processes the payments received from customers.

The CSM accounting system will also handle payments (Accounts Payable) to the product vendors. These payments are based upon the usage metered across the applications and services provided by the product vendor across the platform. This information is fed into an CSM accounts payable (AP) system which releases payment to the vendors.

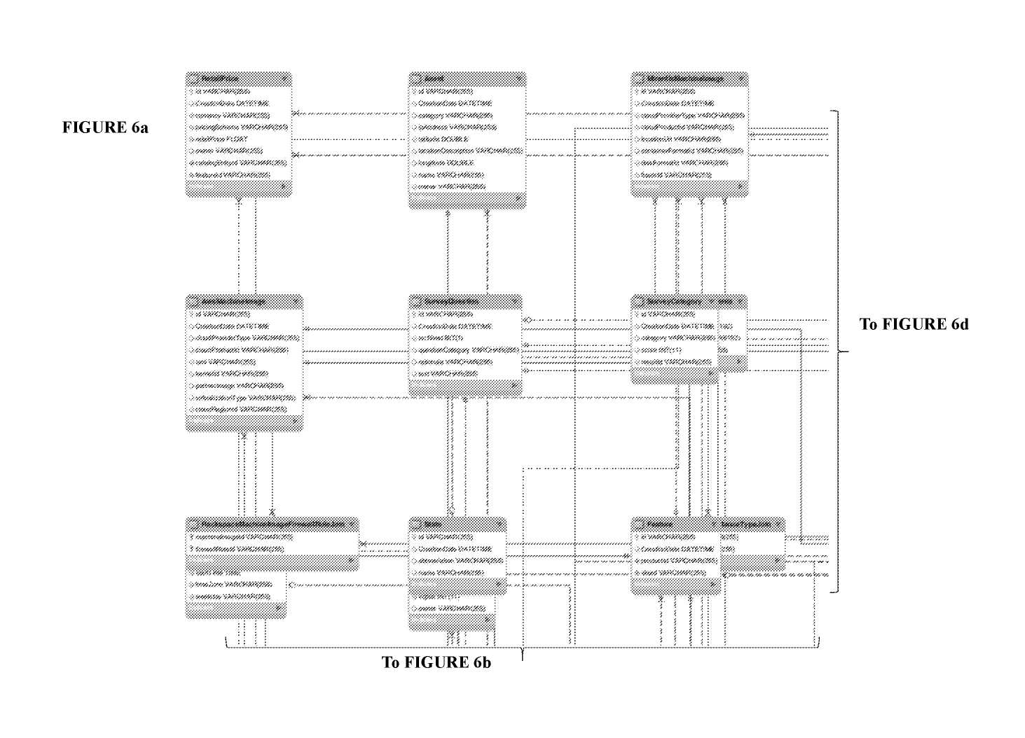

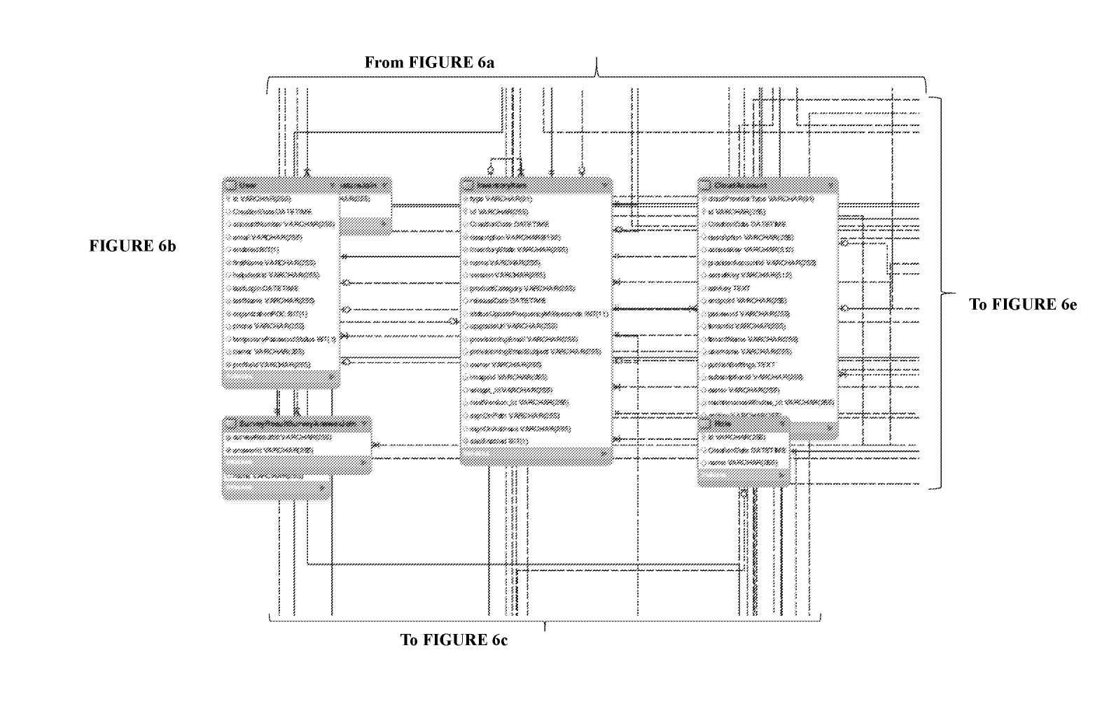

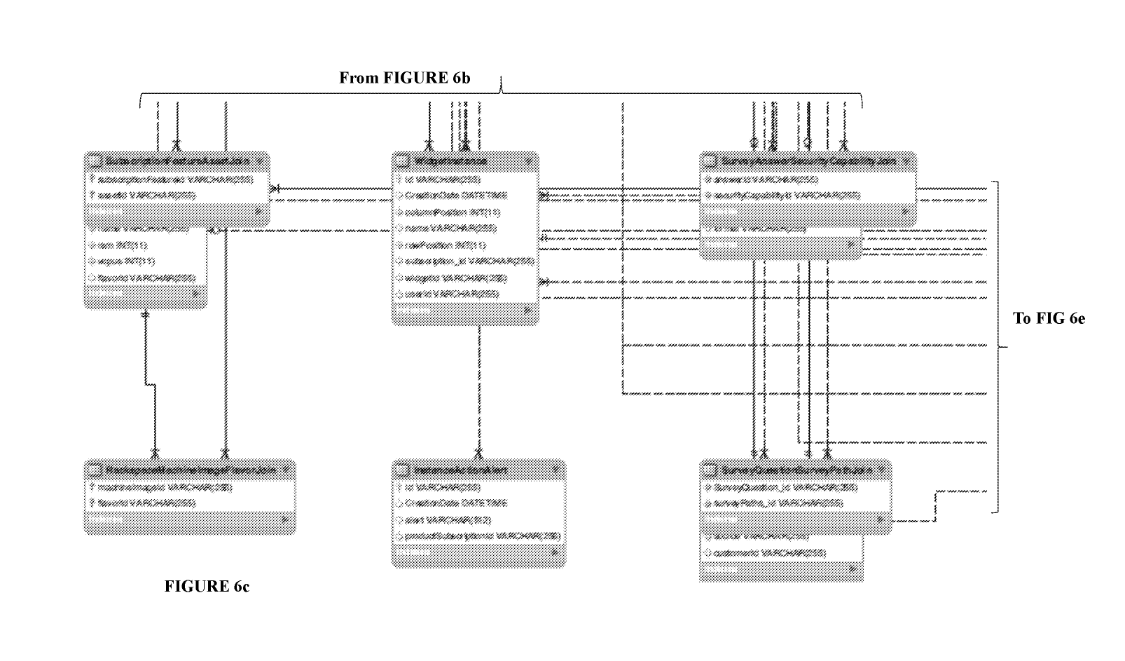

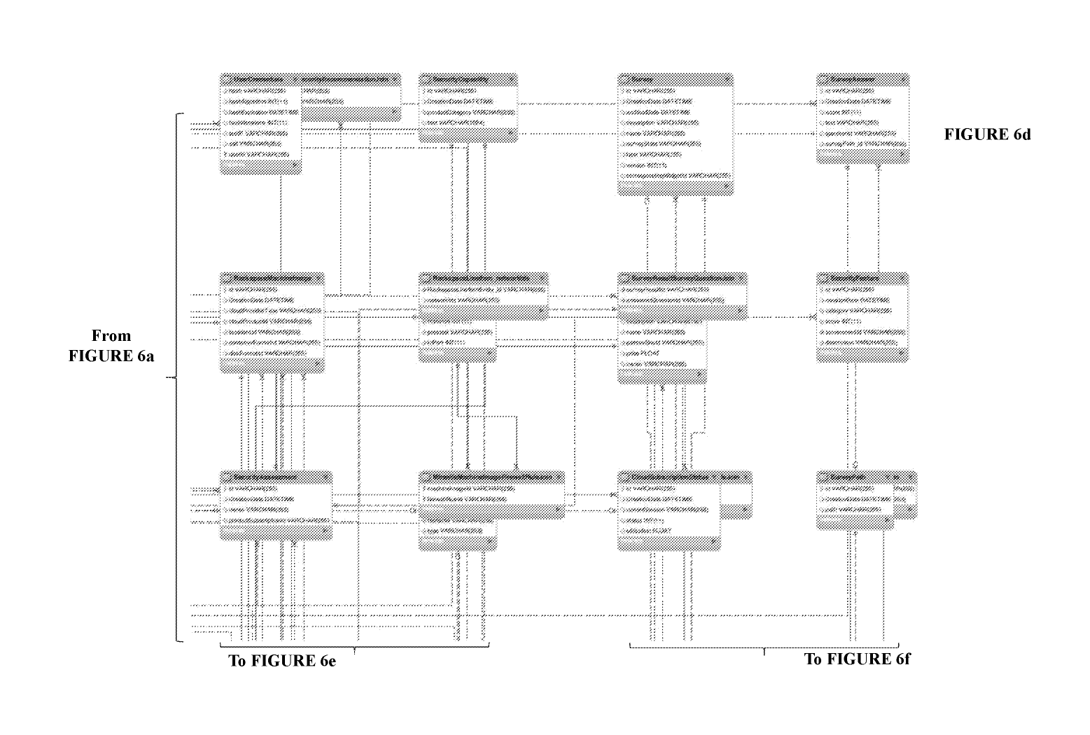

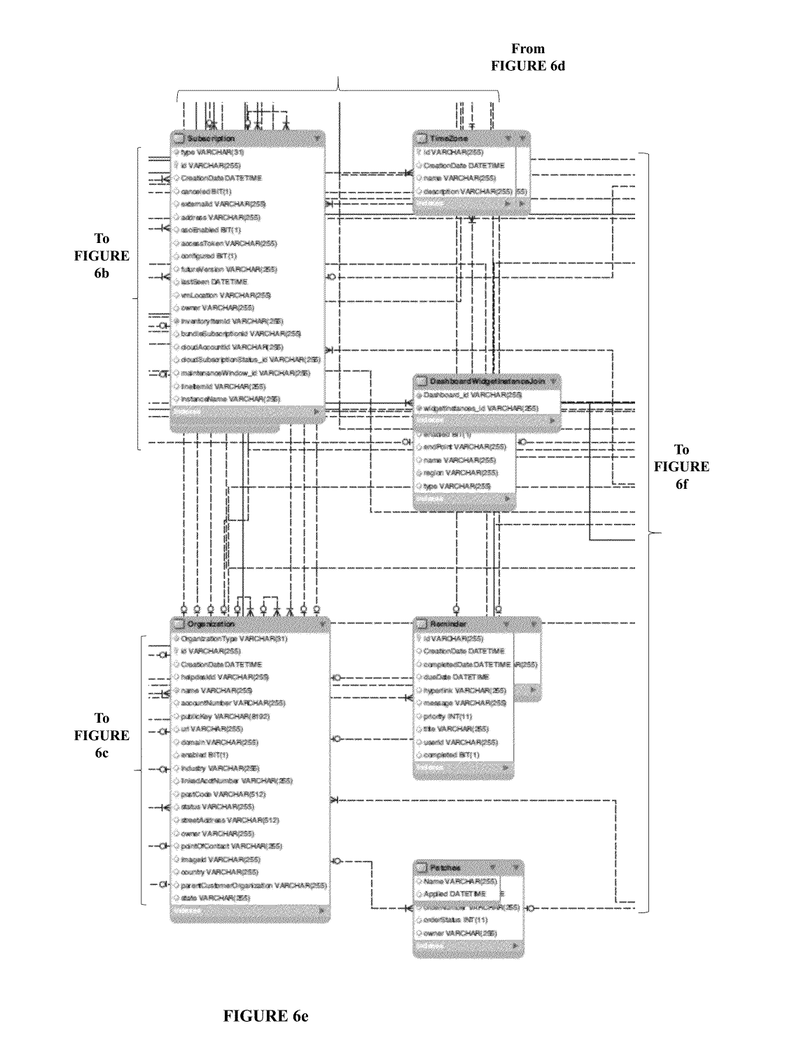

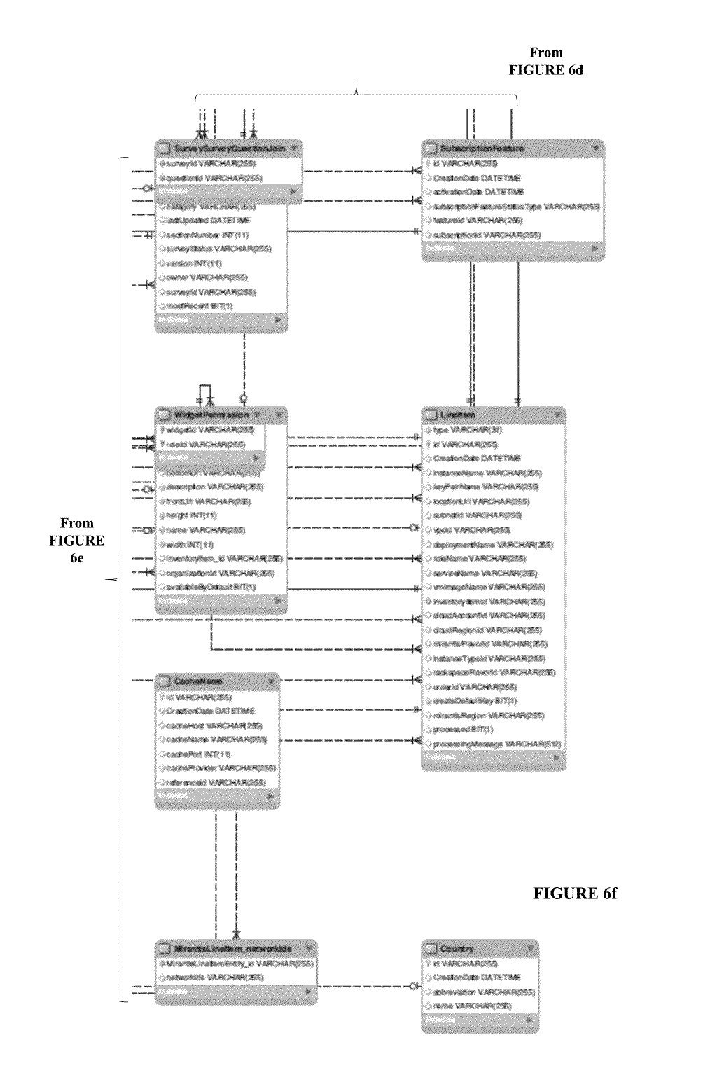

FIGS. 6a-6f provide an entity relationship diagram (ERD) for an exemplary CSM embodiment discussed herein. One skilled in the art will appreciate that there may be certain variations to the diagram that would be contemplated by a database architect implementing the CSM functionality and that these variations are considered to be within the scope of the present invention. Additionally, references to particular products and vendors, e.g., Mirantis, AWS, RackSpace, are representative only and are not intended to limit the scope of the embodiments thereto. One skilled in the art appreciates that competing vendors and products are available to implement the functionality described herein.

1. A system for the automated provisioning and tracking of cloud-implemented security products for protecting an entity's digital assets comprising:
a first application programming interface for receiving security product data from one or more security product vendors and storing the security product data in a relational database;
a second application programming interface for receiving entity data and storing the entity data in the relational database, wherein the entity data is associated with one or more digital assets of the entity and further wherein the digital assets are accessible through the entity's virtual private cloud;
a processing engine for comparing the received entity data with the received security product data and providing at least one recommendation to the entity for a security product from the one or more security product vendors to protect one or more digital assets of the entity;
a provisioning component for receiving instructions from the second application programming interface to provision the at least one recommended security product in the entity's virtual private cloud;
the processing engine further being configured for continually tracking the provisioned instance of the security product, including usage thereof, and comparing provisioned instance tracking data to additional received security product data from the first application programming interface and additional received entity data from the second application programming interface to continually assess a security risk to one or more digital assets of the entity and provide additional security product recommendations.

2. The system according to claim 1, further comprising a third application programming interface for facilitating the population and updating of the relational database with digital asset security standards compliance requirements, wherein the processing engine applies the digital asset security standards compliance requirements to the received entity data and the received security product data as part of the comparing for the at least one recommendation.

3. The system according to claim 1, wherein the at least one recommended security product is a new security product for the entity.

4. The system according to claim 3, wherein the provisioning component provisions an initial instance of the new security product in the entity's virtual private cloud.

5. The system according to claim 1, wherein the at least one recommended security product is an update to an existing security product for the entity.

6. The system according to claim 5, wherein the provisioning component updates an existing instance of the existing security product in the entity's virtual private cloud.

7. The system according to claim 1, wherein the security product data from the one or more security product vendors includes a SKU for each security product, the digital asset protected by each security product and at least one attribute indicative of the nature of the protection afforded by each digital security product.

8. A method for facilitating the automated provisioning and tracking of cloud-implemented security products for protecting an entity's digital assets comprising:
receiving via a first application programming interface security product data from one or more security product vendors and storing the security product data in a relational database;
receiving via a second application programming interface entity data and storing the entity data in the relational database, wherein the entity data is associated with one or more digital assets of the entity and further wherein the digital assets are accessible through the entity's virtual private cloud;
comparing by a processing engine the received entity data with the received security product data;
providing to the entity via the first application programming interface at least one recommendation for a security product from the one or more security product vendors to protect one or more digital assets of the entity;
receiving by a provisioning component instructions to provision the at least one recommended security product in the entity's virtual private cloud;
continually tracking by the processing engine the provisioned instance of the security product, including usage thereof, and comparing provisioned instance tracking data to additional received security product data from the first application programming interface and additional received entity data from the second application programming interface to continually assess a security risk to one or more digital assets of the entity and provide additional security product recommendations.

9. The method according to claim 8, further comprising facilitating by a third application programming interface the population and updating of the relational database with digital asset security standards compliance requirements, wherein the processing engine applies the digital asset security standards compliance requirements to the received entity data and the received security product data as part of the comparing for the at least one recommendation.

10. The method according to claim 8, wherein the at least one recommended security product is a new security product for the entity.

11. The method according to claim 10, wherein the provisioning component provisions an initial instance of the new security product in the entity's virtual private cloud.

12. The method according to claim 8, wherein the at least one recommended security product is an update to an existing security product for the entity.

13. The method according to claim 12, wherein the provisioning component updates an existing instance of the existing security product in the entity's virtual private cloud.

14. The method according to claim 8, wherein the security product data from the one or more security product vendors includes a SKU for each security product, the digital asset protected by each security product and at least one attribute indicative of the nature of the protection afforded by each digital security product.
